(19) United States
(12) Patent Application Publication
(10) Pub. No.: US 2014/0209250 A1
(43) Pub. Date: Jul. 31, 2014

(54) DETACHING APPARATUS AND DETACHING METHOD

(71) Applicant: DAINIPPON SCREEN MFG. CO., LTD., Kyoto (JP)

(72) Inventors: Masafumi KAWAGOE, Kyoto (JP); Kazuhiro SHOJI, Kyoto (JP); Yayoi SHIBAFUJI, Kyoto (JP); Mikio MASUICHI, Kyoto (JP); Hiroyuki UENO, Kyoto (JP); Miyoshi UENO, Kyoto (JP); Kazutaka TANIGUCHI, Kyoto (JP)

(73) Assignee: DAINIPPON SCREEN MFG. CO., LTD., Kyoto (JP)

(21) Appl. No.: 14/146,835

(22) Filed: Jan. 3, 2014

(30) Foreign Application Priority Data
Jan. 30, 2013 (JP) 2013-016036
Mar. 27, 2013 (JP) 2013-065522

(51) Int. Cl. B32B 43/00

(52) U.S. Cl. CPC B32B 43/006
USPC 156/701; 156/764

(57) ABSTRACT

In a detaching apparatus, a detachment starter bends one end part of a first plate-like body into a cylindrical or prismatic surface in a direction opposite to a second plate-like body, thereby forming a single and straight boundary line between an adhering region and a detached region. A separator increases a distance between a first holder holding the first plate-like body and a second holder holding the second plate-like body to separate the first and second plate-like bodies.

### CROSS REFERENCE TO RELATED APPLICATION

The disclosure of Japanese Patent Applications enumerated below including specifications, drawings and claims is incorporated herein by reference in its entirety:
No. 2013-16036 filed on Jan. 30, 2013; and
No. 2013-65522 filed on Mar. 27, 2013.

### BACKGROUND OF THE INVENTION

1. Field of the Invention

The present invention relates to a detaching apparatus and a detaching method for detaching and separating two plate-like bodies adhering to each other.

2. Description of the Related Art

A technique for transferring a pattern or a thin film (hereinafter, referred to as “pattern or the like”) carried on a plate-like body to a substrate is known as a technique for forming a predetermined pattern or a thin film on another plate-like body such as a glass substrate or a semiconductor substrate. In this technique, after the pattern or the like is transferred from one to the other by bringing two plate-like bodies into close contact, the two plate-like bodies need to be detached without damaging the pattern or the like.

For this purpose, two substrates stuck together are held in a horizontal posture and the upper and lower substrates are moved in separating directions while being vacuum-sucked, for example, in the technique disclosed in JP2008-287949A. At this time, by successively elevating a multitude of suction pads for locally sucking the upper substrate from one end side of the substrate, detachment progresses from one end toward the other end of the substrate. Further, a configuration is disclosed which pushes up an end part of one substrate to trigger the separation of the substrates in an initial stage of the detachment. Further, a technique for forming a clearance between a stage and a sheet by inserting a wedge-shaped detaching claw to take out the sheet placed on the stage is disclosed in JP2003-072123A.

A transfer technique of this type has been and is being applied to various device manufacturing processes. With the diversification of materials of patterns and the like, the miniaturization of patterns, the enlargement of substrates and the like, more precise progress management has been necessary in a detaching process. In the detaching process, a boundary line between an already detached region and an undetached region moves toward the undetached region between the two plate-like bodies, whereby the two plate-like bodies are finally entirely detached. If a moving speed of this boundary line, i.e. a detaching speed varies, the damage of the pattern or the like due to stress concentration is likely to occur. Particularly, in an initial stage of the detaching process, a variation in the detaching speed due to the shape change of the boundary line is likely to occur since the shape of the boundary line is not stable.

However, with the above conventional technique, the detaching speed cannot be so strictly managed. Particularly, there has been no way of suppressing a variation in the detaching speed due to a local shape change of the boundary line. Thus, in terms of preventing the damage of the pattern or the like, the above conventional technique has had room for improvement.

### SUMMARY OF THE INVENTION

This invention was developed in view of the above problem and aims to provide a technique capable of satisfactorily detaching two plate-like bodies without damaging a pattern or the like even if the pattern or the like is carried between the two plate-like bodies in a detaching apparatus and a detaching method for detaching and separating the two plate-like bodies adhering to each other.

One aspect of a detaching apparatus according to this invention is a detaching apparatus for detaching a first plate-like body and a second plate-like body adhering to each other. To achieve the above object, the detaching apparatus includes a first holder that holds the first plate-like body; a detachment starter that bends one end part of the first plate-like body into a cylindrical or prismatic surface in a direction opposite to the second plate-like body, thereby converting a part of an adhering region of the second plate-like body adhering to the first plate-like body into a detached region detached from the first plate-like body and forming a single and straight boundary line between the adhering region and the detached region; a second holder that holds the second plate-like body formed with the detached region; and a separator that increases a distance between the first and second holders to separate the first and second plate-like bodies.

Further, one aspect of a detaching method according to this invention is a detaching method for detaching a first plate-like body and a second plate-like body adhering to each other. To achieve the above object, the detaching method includes a boundary line forming step of bending one end part of the first plate-like body into a cylindrical or prismatic surface in a direction opposite to the second plate-like body, thereby converting a part of an adhering region of the second plate-like body adhering to the first plate-like body into a detached region detached from the first plate-like body and forming a single and straight boundary line between the adhering region and the detached region; and a detaching step of moving the boundary line toward the adhering region while maintaining the boundary line straight by relatively moving the first and second plate-like bodies in a separating direction.

In the invention thus configured, prior to the separation of the first and second plate-like bodies adhering to each other, the one end part of the first plate-like body as one component is bent toward a side opposite to the second plate-like body, thereby triggering the detachment. At this time, by bending the first plate-like body into the cylindrical or prismatic surface, the boundary line between the adhering region and the detached region can be formed into a straight line. By forming the boundary line in an initial stage into a straight line in this way, the straight boundary line can move toward the adhering region in the process of separating the first and second plate-like bodies, and a change in a detaching speed due to a shape variation of the boundary line can be suppressed. Thus, in the invention, the detachment can be caused to progress by more strictly managing the detaching speed. For example, even if a pattern or the like (pattern or thin film) is carried between two plate-like bodies, the detachment can be performed while preventing the damage thereof.

Another aspect of the detaching apparatus according to this invention is a detaching apparatus for detaching a first plate-like body and a second plate-like body adhering to each other via a thin film or a pattern. To achieve the above object, the detaching apparatus includes a holder that has a holding surface larger than a planar size of an effective region of the first plate-like body in which the thin film or the pattern is effectively carried and is configured to hold the first plate-like body by the contact of the holding surface with a surface of the first plate-like body opposite to a surface adhering to the second plate-like body; a contactor that has a roller shape whose axial direction is perpendicular to a detachment progressing direction, is configured to be movable in the detachment progressing direction and forms a contact nip between the second plate-like body and the contactor by coming into contact with a surface of the second plate-like body opposite to a surface adhering to the first plate-like body at a contact start position downstream of the one end part in the detachment progressing direction, the detachment progressing direction being a direction from one end part to another end part of the second plate-like body along the second plate-like body; a detacher that holds and moves the one end part in a direction away from the holder, thereby detaching the one end part from the first plate-like body; an imager that images a boundary line formed on a boundary between an undetached region of the first plate-like body adhering to the second plate-like body and a detached region thereof detached from the second plate-like body via the first plate-like body; and a movement controller that detects the position of the boundary line based on an image imaged by the imager and controls a movement of the contactor based on the detection result, wherein the contactor starts moving in the detachment progressing direction from the contact start position when the boundary line reaches a position corresponding to an upstream end part of the contact nip in the detachment progressing direction.

Further, another aspect of the detaching method according to this invention is a detaching method for detaching a first plate-like body and a second plate-like body adhering to each other via a thin film or a pattern. To achieve the above object, the detaching method includes a step of holding the first plate-like body by bringing a surface opposite to a surface adhering to the second plate-like body into contact with a holding surface larger than a planar size of an effective region of the first plate-like body in which the thin film or the pattern is effectively carried; a step of forming a contact nip by bringing a roller-shaped contactor whose axial direction is perpendicular to a detachment progressing direction into contact with a surface of the second plate-like body opposite to a surface adhering to the first plate-like body at a contact start position downstream of the one end part in the detachment progressing direction, the detachment progressing direction being a direction from one end part to another end part of the second plate-like body is the detachment progressing direction along the second plate-like body; a step of moving the one end part of the second plate-like body in a direction away from the first plate-like body, thereby detaching the one end part of the second plate-like body from the first plate-like body; a step of imaging a boundary line formed on a boundary between an undetached region of the first plate-like body adhering to the second plate-like body and a detached region thereof detached from the second plate-like body via the first plate-like body; and a step of calculating a time, at which the boundary line reaches a position corresponding to an upstream end part of the contact nip in the detachment progressing direction, based on an imaged image and causing the contactor to start moving in the detachment progressing direction from the contact start position at the calculated time.

The boundary line is formed on the boundary between the undetached region where the both are in an adhering state before the detachment and the detached region where they are already detached. When the detachment is caused to progress by relatively moving the two plate-like bodies in separating directions, it is necessary to move the boundary line at a constant speed in satisfactorily performing the detachment. This is because a stress may locally concentrate on a pattern or the like carried between the plate-like bodies to damage the pattern or the like if a moving speed of the boundary line varies. In the invention, the detachment is caused to progress by bringing the roller-shaped contactor into contact with the second plate-like body and moving the contactor in the detachment progressing direction. Since the boundary line does not move beyond a contact position with the contactor, the progress of the detachment can be properly managed by the contactor.

However, to achieve such an effect by the contactor, the movement of the boundary line and that of the contactor need to be synchronized in the initial stage of the detachment. This is because the movement of the boundary line is stopped or the speed thereof cannot be managed if there is a deviation between them. The moving speed of the boundary line is unstable particularly in the initial stage of the detachment.

Accordingly, in the above aspect of the invention, the boundary line is imaged via the first plate-like body and a movement start timing of the contactor is controlled based on that result. The boundary line can be easily observed via the first plate-like body due to a difference in refractive index between the pattern or the like and the second plate-like body and a surrounding atmosphere. Accordingly, the movement of the contactor can be started in accordance with the movement of the boundary line regardless of the instability of the moving speed of the boundary line in the initial stage by observing an actual moving condition of the boundary line and determining the movement start timing of the contactor. Thus, according to the invention, a deviation between the movement of the contactor and that of the boundary line can be suppressed and the two plate-like bodies can be satisfactorily detached without damaging the pattern or the like formed between them.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view showing a first embodiment of a detaching apparatus according to the present invention;

FIGS. 2A and 2B are views showing a main part of the detaching apparatus;

FIG. 3 is a block diagram showing the electrical configuration of this detaching apparatus;

FIGS. 4A and 4B are views showing a positional relationship between the stage and a laminated body placed thereon;

FIG. 5 is a flow chart showing a detaching process;

FIGS. 6A to 6C, 7A and 7B are views showing a positional relationship of each component in each stage during the process and diagrammatically showing the progress of the process;

FIGS. 8A to 8C are views showing a relationship between the detachment boundary line and the detaching speed;

FIG. 9 is a perspective view showing a second embodiment of a detaching apparatus according to the present invention;

FIG. 10 is a perspective view showing a main configuration of the detaching apparatus;

FIGS. 11A and 11B are perspective views showing a more detailed configuration of the stage;

FIGS. 12A and 12B are side views showing the structure of the initial detaching unit and a positional relationship of each component;

FIG. 13 is a view showing a positional relationship between the stage and the work placed thereon;

FIG. 14 is a block diagram showing the electrical configuration of the detaching apparatus;

FIG. 15 is a flow chart showing a detaching process; and

FIGS. 16A, 16B, 17A to 17C and 18A to 18D are views showing a positional relationship of each component in each stage of the process and diagrammatically showing the progress of the process.

### DETAILED DESCRIPTION OF THE PREFERRED EMBODIMENTS

### First Embodiment

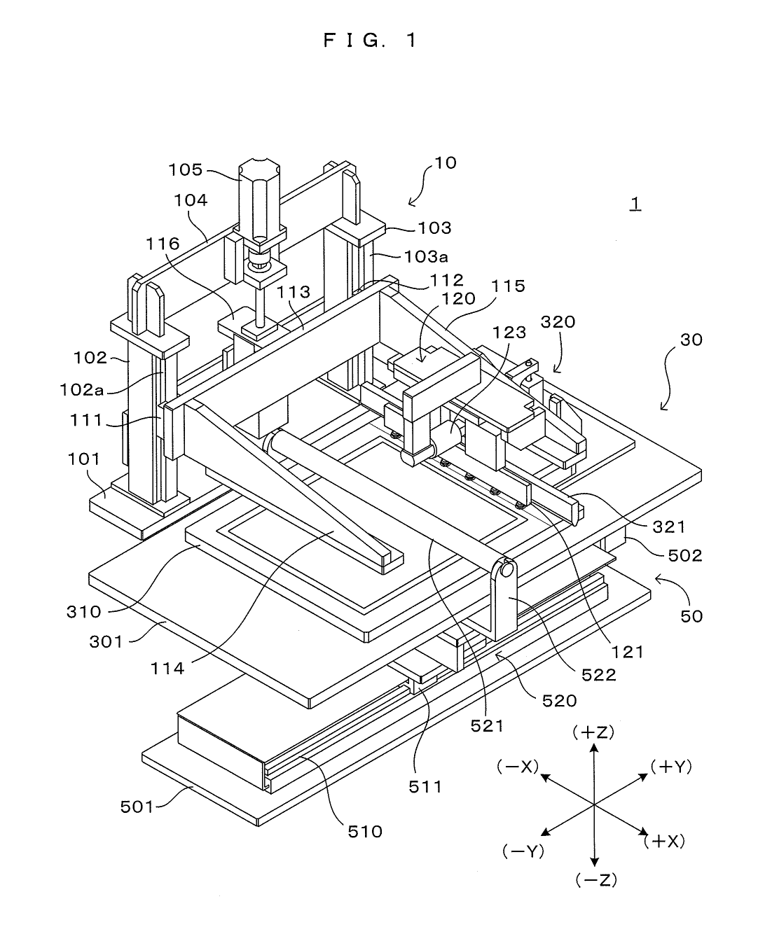

FIG. 1 is a perspective view showing a first embodiment of a detaching apparatus according to the present invention. XYZ orthogonal coordinate axes are set as shown on a right lower side of FIG. 1 to show directions in each figure in a unified manner. Here, an XY plane represents a horizontal plane and a Z axis represents a vertical axis. More specifically, a (+Z) direction represents a vertically upward direction. Note that, in each of the subsequent figures, dimensions of each component may be appropriately enlarged or reduced to facilitate the understanding of the invention. Thus, thicknesses of a substrate and a blanket to be described later and a distance between the both may be particularly shown larger than they actually are.

The detaching apparatus 1 is an apparatus for detaching two plate-like bodies loaded in a state where principle surfaces adhere to each other. For example, the apparatus 1 can be used in a part of a pattern formation process for forming a predetermined pattern on a surface of a substrate such as a glass substrate or a semiconductor substrate. More specifically, in this pattern formation process, a pattern forming material is uniformly applied to a blanket surface as a carrier for temporarily carrying a pattern to be transferred to a substrate as a transferred body (applying step), and a coating layer on the blanket is patterned by pressing a plate surface-processed in conformity with a pattern shape against the coating layer (patterning step). Then, by causing the blanket formed with a pattern in this way to adhere to the substrate (transferring step), the pattern is finally transferred from the blanket to the substrate.

At this time, for the purpose of separating the plate and the blanket caused to adhere in the patterning step or the substrate and the blanket caused to adhere in the transferring step, this apparatus can be suitably applied. Of course, this apparatus may be used for both of these or may be used in other applications. For example, this apparatus can be applied also to a detaching process in transferring a thin film carried on a carrier to a substrate.

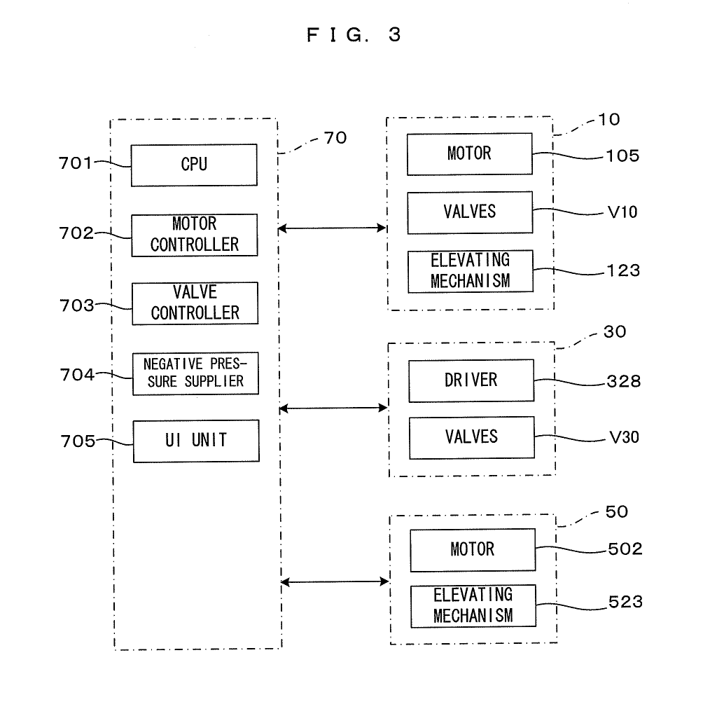

The detaching apparatus 1 is so structured that an upper unit 10, a center unit 30 and a lower unit 50 are respectively installed in a housing. In FIG. 1, the housing is not shown to show an internal structure of the apparatus. Further, the detaching apparatus 1 includes a control unit 70 (FIG. 3) to be described later.

In the upper unit 10, a pair of support columns 102, 103 stand side by side at a predetermined distance from each other in a Y direction on the upper surface of a support base 101 fixed to the housing, and a beam member 104 is laid on the tops of these support columns. Guide rails 102a, 103a extending in the vertical direction (Z direction) are respectively attached to (+X) side surfaces of the support columns 102, 103. Sliders 111, 112 are respectively attached to the guide rails 102a, 103a slidably in the vertical direction. These sliders 111, 112 are respectively attached to opposite end parts of an arm support plate 113 extending in the Y direction.

A pair of arms 114, 115 extending in a (+X) direction are attached to the opposite end parts of the arm support plate 113, and various processing blocks can be mounted on these arms. In this embodiment, an upper suction block 120 as a processing block is mounted on one arm 115 on a (+Y) side. The upper suction block 120 will be described later.

A plate elevating mechanism 116 is provided on a (−X) side surface of the arm support plate 113 and connected to a rotary shaft of a motor 105 attached to the beam member 104 located above the plate elevating mechanism 116. When the rotary shaft of the motor 105 rotates, its rotational movement is translated into a vertical movement by a translation mechanism such as a ball screw mechanism provided in the plate elevating mechanism 116. Thus, the arm support plate 113 moves in the Z direction along the guide rails 102a, 103a. Associated with this, the upper suction block 120 attached to the arm 115 also moves in the Z direction.

Next, the configuration of the center unit 30 is described. In the center unit 30, a stage 310 is installed in a substantially central part of the upper surface of a support base 301 fixed to the housing. Although described in detail later, when a laminated body composed of a plate and a blanket adhering via a coating layer or a laminated body composed of a substrate and a blanket adhering via a pattern is loaded into the detaching apparatus 1 from the outside, the laminated body is placed on the upper surface of the stage 310. The stage 310 has a larger planar size than the laminated body to be placed thereon.

An initial detaching block 320 is attached to a (+Y) side of the stage 310 on the support base 301. The block 320 is for starting detachment by bending an end part of the laminated body placed on the upper surface of the stage 310 downward. The initial detaching block 320 will be described in detail later.

In the lower unit 50, a support base 501 fixed to the housing extends in the Y direction below the support base 301 of the center unit 30 and a guide rail 510 is mounted on the upper surface thereof. A slider 511 is slidably attached to the guide rail 510 and supports a pressing roller block 520. Accordingly, the pressing roller block 520 is movable in the Y direction.

The pressing roller block 520 includes a roller 521 extending in the X direction above the stage 310 of the center unit 30, a roller holder 522 including a horizontal section extending in the X direction below the stage 310 and vertical sections projecting further upward than the upper surface of the stage 310 from the opposite ends of the horizontal section and configured to rotatably hold the opposite ends of the roller 521 by the vertical sections, and an elevating mechanism 523 (FIG. 3) for changing the height of the roller 521 by moving the roller holder 522 in the Z direction although hidden in FIG. 1.

The lower unit 50 further includes a motor 502, and a rotational movement of the motor 502 is translated into a linear movement in the Y direction by an unillustrated translation mechanism to drive the pressing roller block 520. Specifically, the pressing roller block 520 moves in the Y direction along the guide rail 510 by the rotation of the motor 502.

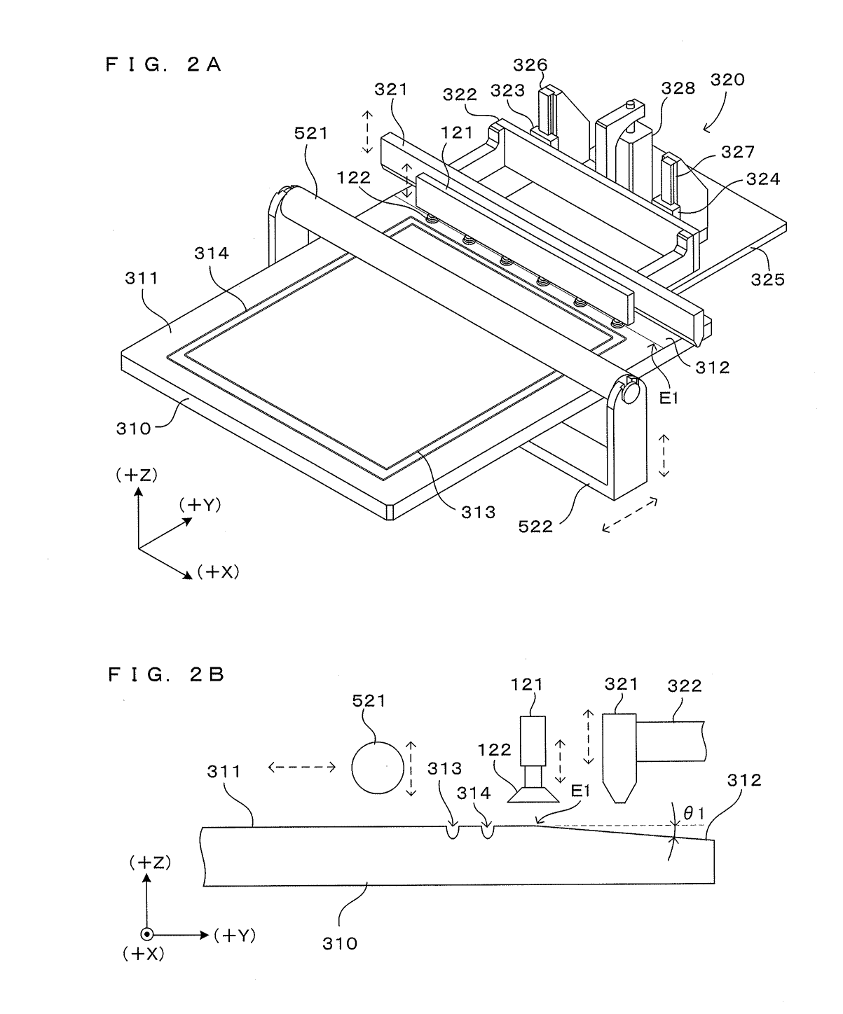

FIGS. 2A and 2B are views showing a main part of the detaching apparatus. More specifically, FIG. 2A is a perspective view and FIG. 2B is a partial sectional view along a Y-Z plane showing the arrangement of a peripheral configuration of the stage 310. In FIGS. 2A and 2B, broken line arrows indicate movable directions of each constituent element.

A plurality of grooves are engraved on the stage 310. Specifically, an annular groove 313 having a rectangular ring shape to surround a central part of the stage 310 is provided at the innermost side. A groove 314 having a substantially rectangular shape is provided adjacent to outer (±X) sides and (±Y) sides of the annular groove 313. Note that the groove 314 needs not have a ring continuous shape. For example, some of four sides of the rectangular shape may not be connected.

Any one of a positive pressure, a negative pressure and an atmospheric pressure is individually appropriately supplied to each of these grooves according to a process to be performed. This realizes the suction of an object placed on the stage 310, the release of the suction and the lift of the object. As described later, in this embodiment, the annular groove 313 mainly functions as an atmospheric air release groove open to the atmospheric pressure and the other groove 314 mainly functions as a vacuum suction groove by being supplied with the negative pressure.

As can be understood from FIG. 2B, the upper surface of the stage 310 is formed by a horizontal surface section 311 which is a substantially horizontal flat surface and an inclined surface section 312 which is a flat surface connected to the horizontal surface section 311 and having a predetermined angle of inclination θ1. A ridge section E1 at which the horizontal surface section 311 and the inclined surface section 312 meet is a straight line parallel to the X direction. Although the inclination is emphasized in FIGS. 2A and 2B, the angle of inclination θ1 is about several degrees and, for example, can be set at 2°. The groove 314 is provided on a part of the horizontal surface section 311 near the ridge section E1.

The roller 521 rotatably held by the roller holder 522 extending from below the stage 310 is arranged to extend in the X direction above the horizontal surface section 311 of the stage 310. The roller 521 is movable in the Z direction by the unillustrated elevating mechanism, thereby moving toward and away from the stage 310. Further, the roller 521 moves in the Y direction integrally with the pressing roller block 520 by the rotation of the motor 502 (FIG. 1). The roller 521 does not have a drive source and freely rotates.

A suction mechanism of the upper suction block 120 (FIG. 1) is provided above the ridge section E1 of the stage 310. This suction mechanism includes a head section 121 extending in the X direction and a plurality of suction pads 122 respectively attached to the head section 121 and juxtaposed in the X direction. The suction pads 122 are made of an elastic material such as rubber and can suck an object by being respectively supplied with the negative pressure. The head section 121 is made movable upward and downward by an elevating mechanism 123 (FIG. 1) of the upper suction block 120, whereby the respective suction pads 122 integrally move toward and away from the stage 310. Note that, although not shown, the upper suction block 120 further includes a position adjusting mechanism for adjusting the Y-direction position of each suction pad 122 by moving the head section 121 in the Y direction.

A pressing member 321 of the initial detaching block 320 is arranged above the inclined surface section 312 of the stage 310. More specifically, the initial detaching block 320 includes the pressing member 321 extending in the X direction above the inclined surface section 312 and the pressing member 321 is supported by a support arm 322. The pressing member 321 is formed into a substantially rectangular parallelepipedic shape by one plate-like body, tapered to reduce the width toward one shorter side in a cross-section perpendicular to a longitudinal direction and formed with a flat top surface on the top thereof. The pressing member 321 having such a shape is supported on the support arm 322 with the longitudinal direction thereof aligned with the X direction and the top surface faced down. Opposite end parts of the pressing member 321 in the X direction respectively extend further outward than the end parts of the stage 310 and, hence, extend further outward than end parts of a laminated body to be placed on the stage 310 in the X direction.

The support arm 322 is supported by a pair of sliders 323, 324 slidably attached to a pair of guide rails 326, 327 standing on a base plate 325 fixed to the housing. Further, the initial detaching block 320 includes a driver 328 having a suitable drive source such as a motor or a cylinder, and a drive force of the driver 328 is translated into a linear movement in the Z direction by a translation mechanism such as a ball screw mechanism and transmitted to the support arm 322 if necessary. Accordingly, when the driver 328 is actuated, the support arm 322 moves upward and downward in the Z direction and the pressing member 321 moves upward and downward together with this, thereby moving toward and away from the stage 310. Note that although not shown, the initial detaching block 320 further includes a position adjusting mechanism for adjusting the Y-direction position of the pressing member 321 by moving the guide rails 326, 327 in the Y direction on the base plate 325.

FIG. 3 is a block diagram showing the electrical configuration of the detaching apparatus. Each apparatus component is controlled by the control unit 70. The control unit 70 includes a CPU (Central Processing Unit) 701 in charge of the operation of the entire apparatus, a motor controller 702 for controlling motors provided in the respective components, a valve controller 703 for controlling valves provided in the respective components, a negative pressure supplier 704 for generating a negative pressure to be supplied to each component, and a user interface (UI) unit 705 for receiving an operation input from a user and notifying a state of the apparatus to the user. Note that the control unit 70 may not include the negative pressure supplier if a negative pressure supplied from the outside is usable.

The motor controller 702 controls the motor 105 provided in the upper unit 10, the elevating mechanism 123 provided in the upper suction unit 120, the driver 328 provided in the initial detaching block 320 of the center unit 30, the motor 502 and the elevating mechanism 523 provided in the lower unit 50, and the like. The valve controller 703 controls valves V10 provided on a piping route extending from the negative pressure supplier 704 to the suction pads 122 and configured to supply a predetermined negative pressure to the suction pads 122, valves V30 provided on a piping route extending from the negative pressure supplier 704 to the vacuum suction groove provided on the stage 310 and configured to supply a predetermined negative pressure to the vacuum suction groove 314, and the like.

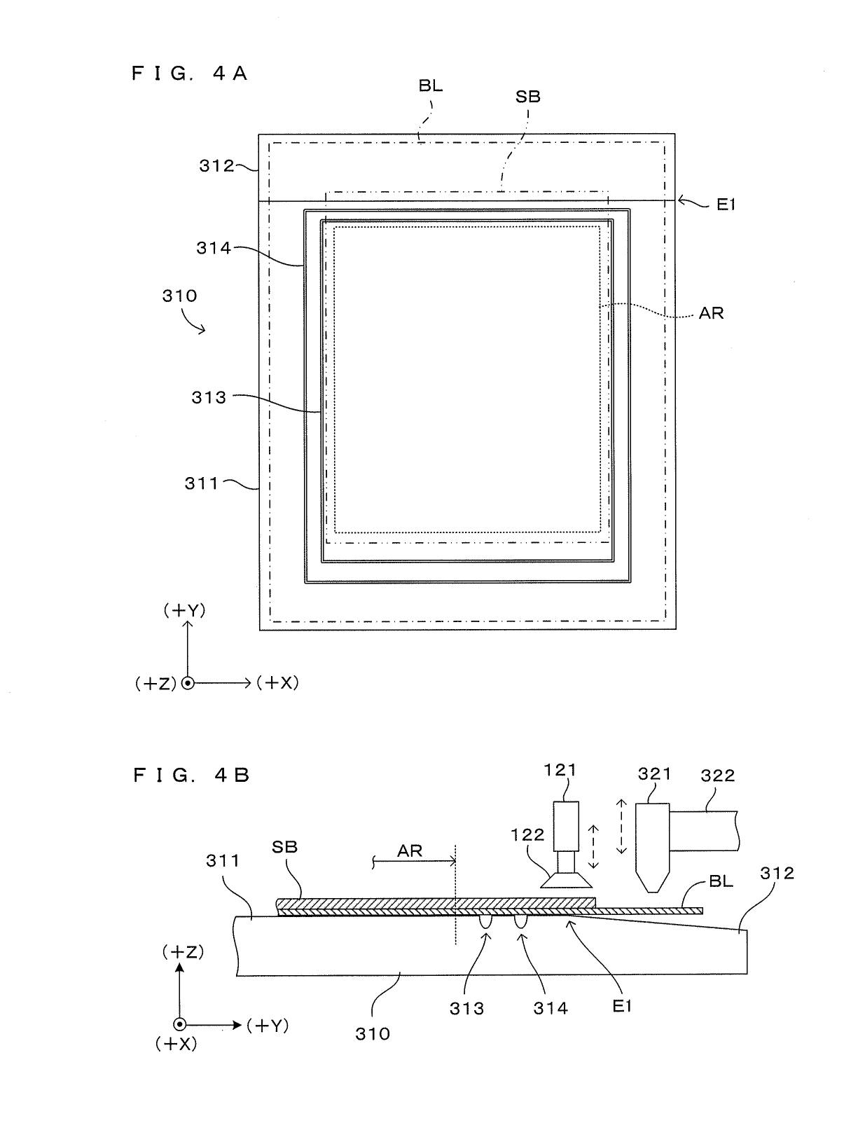

FIGS. 4A and 4B are views showing a positional relationship between the stage and a laminated body placed thereon. More specifically, FIG. 4A is a plan view showing the position of the laminated body placed on the stage 310, and FIG. 4B is a partial side view showing a state where the laminated body is placed on the stage 310. Here, a case where the laminated body formed by placing a substrate SB, to which a pattern is finally supposed to be transferred, and a blanket LB temporarily carrying the pattern to be transferred to the substrate SB one over the other is placed on the stage 310 is described as an example. A similar thought can be applied also in the case of a laminated body of a plate for patterning the blanket BL and the blanket BL. In this case, the “substrate” may be read by the “plate” in the following description.

In the laminated body composed of the substrate SB and the blanket BL adhering via the pattern, the blanket BL has a larger planar size than the substrate SB. Thus, the entire surface of the substrate SB is facing the blanket BL, whereas a central part of the blanket BL is facing the substrate SB, but a peripheral edge part is a margin part not facing the substrate SB. The pattern is effectively transferred to the central part excluding a peripheral edge part out of a surface area of the substrate SB, thereby setting an effective region AR which functions as a device. Accordingly, the detaching apparatus 1 aims to detach the blanket BL from the substrate SB without damaging the pattern transferred from the blanket BL to the effective region AR of the substrate SB.

As shown in FIG. 4A, the laminated body is so placed on the stage 310 that the entire effective region AR of the substrate SB is located on the horizontal surface section 311 of the stage 310. The arrangement of the annular groove 313 is determined in advance to completely surround the effective region AR at this time. On the other hand, the groove 314 provided to surround the annular groove 313 on the horizontal surface section 311 of the stage 310 is provided at a position to be closed by the blanket BL when the blanket BL is placed on the stage 310.

A (+Y) side end part of the substrate SB is arranged at a position slightly projecting toward the (+Y) side from the ridge section E1 of the stage 310. On the other hand, a (+Y) side end part of the blanket BL largely projects from the ridge section E1 of the stage 310 to extend up to a position above the inclined surface section 312. Thus, the lower surface of the blanket BL is not in contact with the stage 310 in this part and a clearance is formed between the blanket BL and the inclined surface section 312.

The Y-direction positions of the suction pads 122 are so adjusted in advance that the suction pads 122 are located right above the (+Y) side end part of the substrate SB and closer to the (+Y) side than the groove 314 provided on the stage 310. On the other hand, the pressing member 321 is located above the end part of the blanket BL projecting above the inclined surface section 312. Each component operates in response to a control command of the CPU 701 in a state where the laminated body of the substrate SB and the blanket BL is placed on the stage 310 in this way, whereby the substrate SB and the blanket BL are detached.

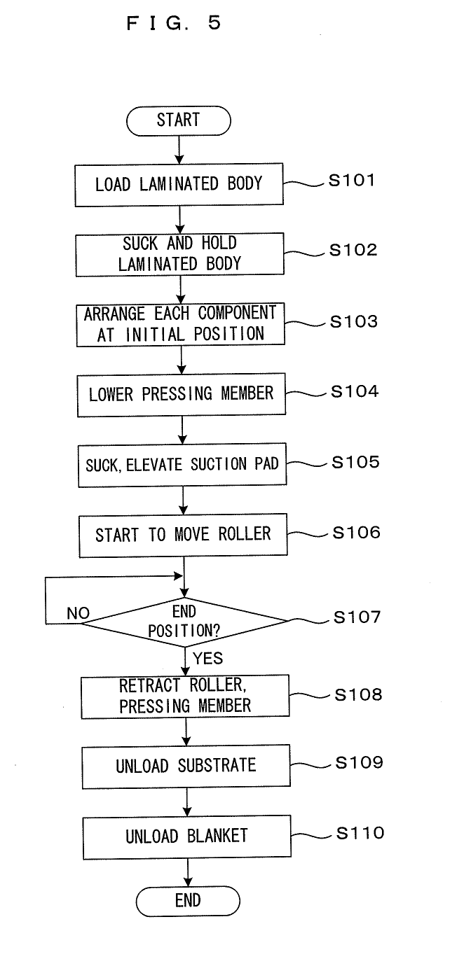

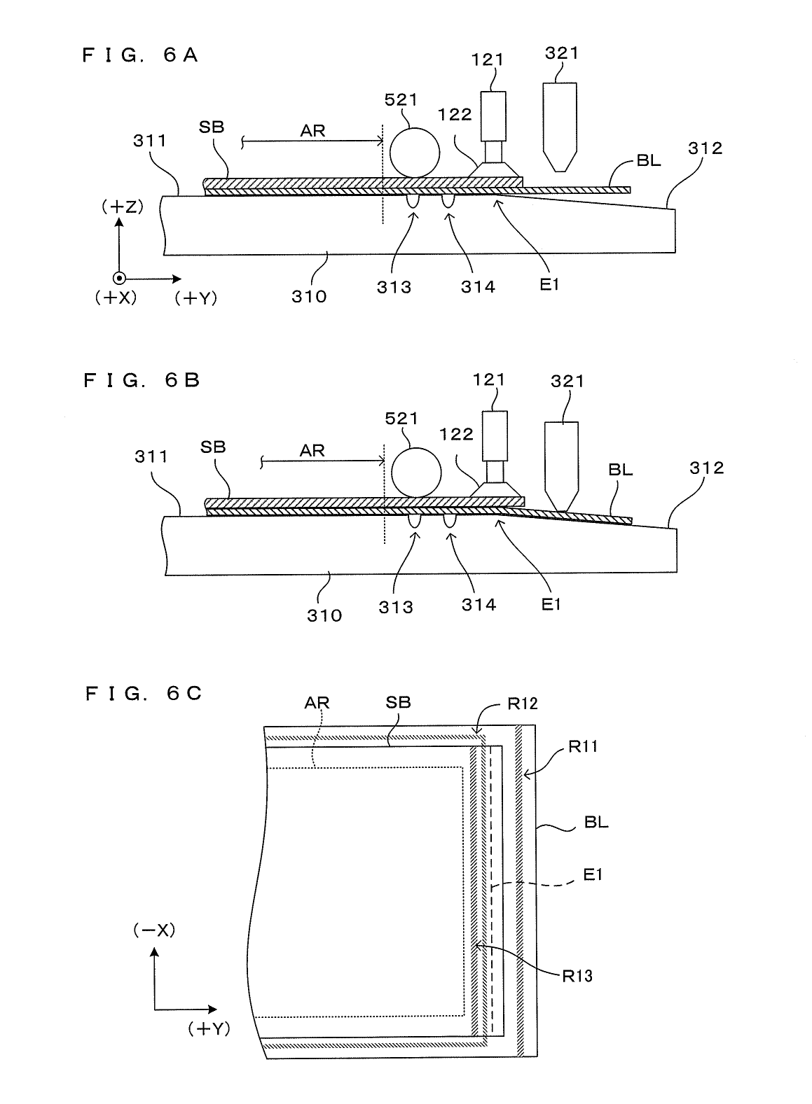

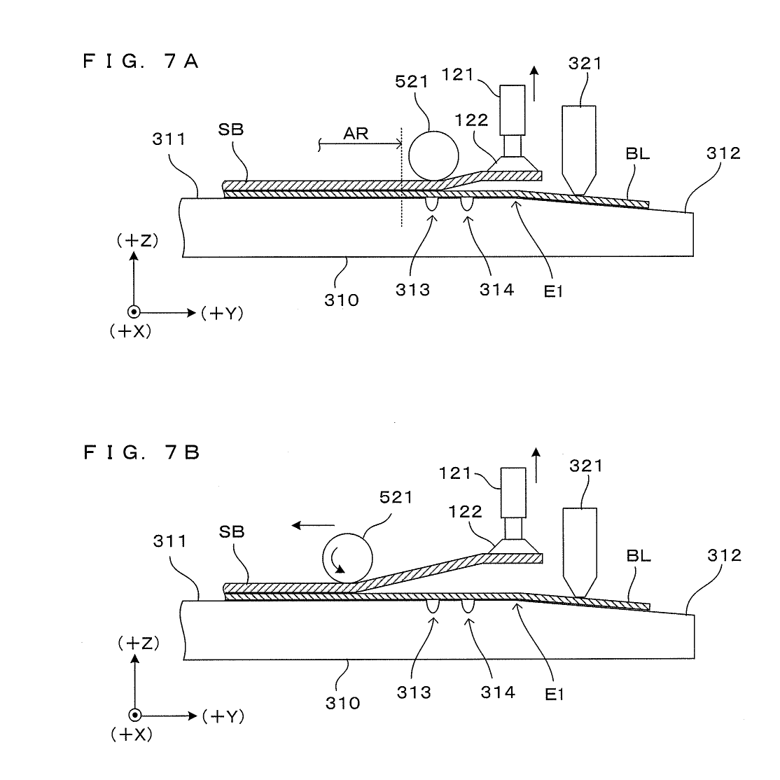

FIG. 5 is a flow chart showing a detaching process. Further, FIGS. 6A to 6C, 7A and 7B are views showing a positional relationship of each component in each stage during the process and diagrammatically showing the progress of the process. This detaching process is performed by the CPU 701 executing a process program stored in advance to control each component.

When the laminated body is loaded and arranged at the above position on the stage 310 by an operator, an external conveyor robot or the like (Step S101), a negative pressure is supplied to the vacuum suction groove 314 of the stage 310 to suction the laminated body. Thus, the laminated body is held onto the stage 310 (Step S102). Subsequently, each component of the apparatus is arranged at an initial position for performing detachment (Step S103). FIG. 6A shows the initial position of each component. As shown in FIG. 6A, the head section 121 is lowered to bring the lower surface of each suction pad 122 into contact with the upper surface of the end part of the substrate SB. At this point, the negative pressure is not supplied to the suction pads 122 yet and the suction pads 122 are merely mechanically pressed against the upper surface of the substrate SB. Further, the pressing member 321 is arranged at a position near the end part of the blanket BL and spaced upward from the upper surface of this end part. Further, the roller 521 is brought into contact with the upper surface of the substrate SB at a position closer to the (+Y) side than the effective region AR of the substrate SB and closer to the (−Y) side than the vacuum suction groove 314.

Subsequently, the pressing member 321 is lowered in this state (Step S104) and further lowered while bringing the lower end (top surface) thereof into contact with the blanket BL. At this time, as shown in FIG. 6B, the (+Y) side end part of the blanket BL is pressed downward by the top surface of the pressing member 321 to be bent downward. On a side closer to the (−Y) side than the ridge section E1, i.e. on the left side in FIG. 6B, the lower surface of the blanket BL is sucked and held on the horizontal surface section 311 of the stage 310, wherefore the deformation of the blanket BL is prevented. Thus, an area where the blanket BL is bent is limited to a side closer to the (+Y) side than the ridge section E1, i.e. the right side in FIG. 6B. Particularly, since a stress is concentrated on the vicinity of the ridge section E1, the blanket BL is likely to be bent in this part.

The pressing member 321 extending in the X direction presses the blanket BL uniformly in the X direction. That is, a pressing force is constant regardless of the X-direction position. Thus, the blanket BL is bent in a uniform manner in the X direction. Specifically, the blanket BL is bent into a cylindrical or prismatic surface having an axis parallel to the X direction. Further, this tendency is more notable since the ridge section E1 of the stage 310 also extends in the X direction. Note that the “cylindrical surface” means a surface consisting of each of the straight lines which are parallel to the X direction and pass through a curve, and the “prismatic surface” means a surface consisting of each of the straight lines which are parallel to the X direction and pass through a broken line.

On the other hand, the substrate SB is formed of a material having a higher rigidity than the blanket BL and the deformation thereof is more limited than that of the blanket BL. That is, the (+Y) side end part of the substrate SB does not follow the downward bending movement of the blanket BL and tries to return to an initial horizontal posture due to the rigidity thereof. Thus, a clearance is formed between the blanket BL bent downward and the substrate SB trying to maintain the horizontal posture, thereby starting partial detachment. That is, the pressing of the blanket BL by the pressing member 321 triggers the separation of the blanket BL and the substrate SB. To prevent the substrate SB from being bent downward together with the blanket BL, the blanket BL needs to have suitable flexibility and the substrate SB needs to be more rigid. Further, the suction pads 122 need to be able to follow the deformation of the substrate SB associated with the pressing of the blanket BL by the pressing member 321, i.e. need to have such a stretch property as not to release a contact state even if the substrate SB is temporarily deflected.

Here, an undetached region where the blanket BL and the substrate SB adhere is referred to as an adhering region, a region where the both are already detached to form a clearance therebetween is referred to as a detached region and a line formed by a boundary between the adhering region and the detached region is referred to as a detachment boundary line and denoted by DL. Since the blanket BL is bent into the cylindrical or prismatic surface having the axis extending in the X direction, the detachment boundary line DL is a single straight line along the X direction.

FIG. 6C is a plan view of the substrate SB and the blanket BL in the state of FIG. 6B. Hatched regions R11, R12 and R13 respectively indicate a region of the blanket BL held in contact with the pressing member 321, a region of the blanket BL sucked by the negative pressure supplied to the vacuum suction groove 314 and a region of the substrate SB held in contact with the roller 521. As shown in FIG. 6C, in an initial stage where the detachment starts, a (+Y) side end part of the effective region AR, the contact region R13 with the roller 521, the sucked region R12, the detachment boundary line DL, a (+Y) side end part of the substrate SB, and the contact region R11 with the pressing member 321 are arranged in this order from a central side of the blanket BL (left side in FIG. 6C) toward the (+Y) side.

By pressing the blanket BL on a side (right side in FIG. 6C) outside the contact region R13 of the roller 521 and the substrate SB and the sucked region R12 of the blanket BL, it is prevented that the deformation of the blanket BL affects the effective region AR. Further, by setting the contact position of the roller 521 outside the effective region AR, the application of a local pressing force from the roller 521 to the pattern within the effective region AR is avoided.

The substrate SB returns to the horizontal state while the blanket BL is bent downward by being pressed by the pressing member 321 in this way, whereby the detachment boundary line DL is formed. Subsequently, as shown in FIG. 5, the negative pressure is supplied to the suction pads 122 held in contact with the upper surface of the substrate SB to suck and hold the substrate SB and the elevation of the suction pads 122 is started (Step S105). In synchronization with the elevation of the suction pad 122, the roller 521 is moved in a direction opposite to the already detached region, i.e. in the (−Y) direction while being held in contact with the upper surface of the substrate SB (Step S106). An elevating speed of the suction pads 122 and a moving speed of the roller 521 are both constant speeds.

When the suction pads 122 are elevated as shown in FIG. 7A, the end part of the substrate SB sucked by the suction pads 122 is lifted and the detachment from the blanket BL progresses. That is, the detachment boundary line moves in the (−Y) direction (leftward direction in FIG. 7A). The movement of the detachment boundary line is limited up to the contact position with the roller 521 by bringing the roller 521 into contact with the upper surface of the substrate SB. Since the roller 521 extends in the X direction, the detachment boundary line is also a straight line extending in the X direction. In this embodiment, a large sucking and holding force is obtained by juxtaposing a plurality of (six in FIG. 2) suction pads 122 in the X direction. Further, the substrate SB is reliably lifted by being sucked at a position as close to the end part of the substrate SB as possible.

In this state, the roller 521 is moved at a constant speed in the (−Y) direction while the suction pads 122 are elevated, whereby the detachment boundary line moves at a constant speed in the (−Y) direction while being maintained as a straight line. Specifically, the detachment progresses in the (−Y) direction as a detaching direction. Since the movement of the roller 521 is started from the position outside the effective region AR, the speed of the roller 521 passing above the effective region AR is constant and a pressing force applied to the pattern from the roller 521 within the effective region AR is uniform regardless of the position.

In this way, the elevation of the suction pads 122 and the movement of the roller 521 are continued. When these reach end positions where the detachment is completed for the entire substrate SB (Step S107), these movements are stopped and the roller 521 and the pressing member 321 are moved to predetermined retracted positions (Step S108). When the suction of the suction pads 122 is released in this state, the substrate SB detached from the blanket SB can be unloaded (Step S109). Subsequently, when the suction by the stage 310 is released, the blanket BL can be unloaded (Step S110). By unloading these, the detaching process is finished.

In the course of the detaching process described above, the annular groove 313 is constantly open to the atmospheric air. Since the blanket BL is vacuum-sucked by the vacuum suction groove 314 provided at the outer side of the annular groove 313, the blanket BL is continuously held even if the annular groove 313 is open to the atmospheric air. On the other hand, by setting the annular groove 313 provided to surround the effective region AR in the state open to the atmospheric air, the following advantages can be obtained.

When the upper surface of the stage 310 is uneven, for example, due to scratches or the adherence of foreign substances, the blanket BL may also be deflected in conformity with the unevenness of the stage if the blanket BL is pressed against the upper surface of the stage 310 by vacuum suction. This may cause the substrate SB to be deflected or the pattern sandwiched between the substrate SB and the blanket BL to be distorted. At any rate, this is an unfavorable phenomenon for the purpose of satisfactorily transferring the pattern to the substrate SB. In this embodiment, the blanket LB is not strongly pressed against the upper surface of the stage 310 in a region at the inner side of the annular groove 313 open to the atmospheric air. Thus, even if the upper surface of the stage is uneven, it is avoided that such unevenness affects the substrate SB and the pattern.

In the pattern transfer from the blanket BL to the substrate SB as described above, the moving speed of the detachment boundary line, i.e. a progressing speed of the detachment (here, referred to as “detaching speed”) is required to be constant in order to transfer the pattern carried on the blanket BL to the substrate SB in a perfect form. This is because, particularly in the case of a fine pattern or depending on the property of the pattern forming material, a shear force is applied to damage the pattern when the detaching speed changes. The same holds true also for patterning from the plate to the blanket BL.

In the above detaching process, the detachment boundary line formed into a straight line in advance can be moved at a constant speed. By setting the moving speed of the detachment boundary line to be constant at least in the effective region AR, it is possible to prevent the damage of the pattern due to a change in the detaching speed.

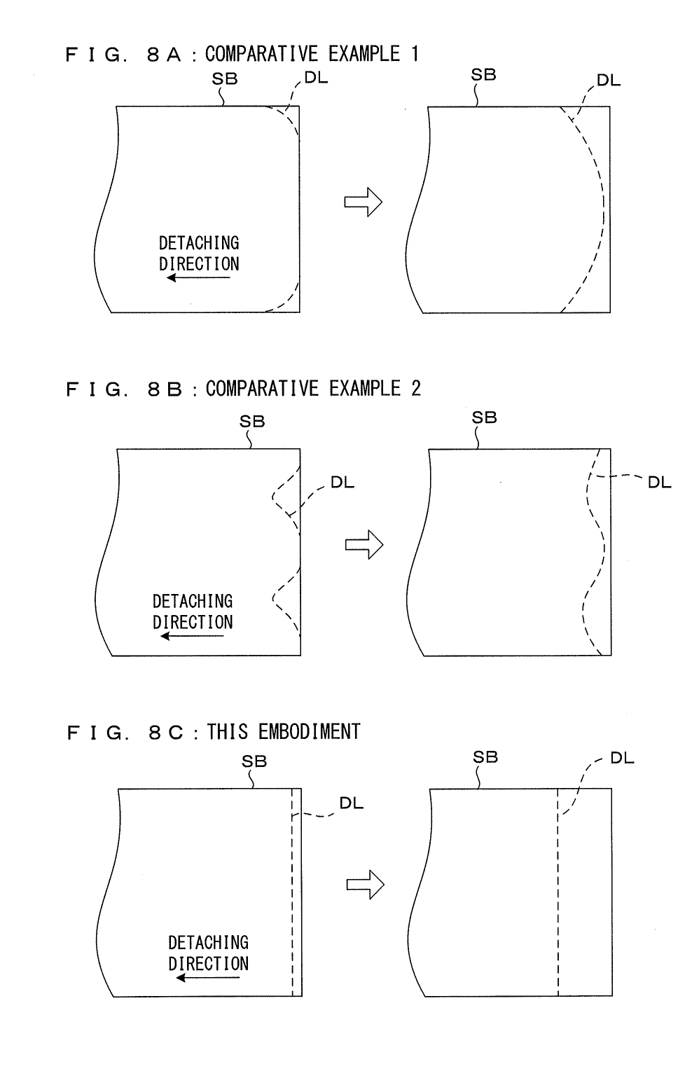

FIGS. 8A to 8C are views showing a relationship between the detachment boundary line and the detaching speed. If the substrate SB and the blanket BL are pulled apart without particularly triggering the separation in the initial stage of the detachment, the detachment generally starts at both corner parts of the substrate SB and detachment boundary lines DL are initially formed at two positions. Thereafter, the two detachment boundary lines DL are united to finally become a straight line by the contact with the roller as shown as Comparative Example 1 in FIG. 8A.

Further, in a configuration for triggering the separation by locally pushing out a blanket or inserting a detaching claw as with the conventional techniques described above, locally large detached regions are formed in the triggered parts and gradually spread to finally form a detachment boundary line DL as shown as Comparative Example 2 in FIG. 8B.

In these configurations, the shapes of the detachment boundary lines formed in the initial stage of the detachment are neither managed nor constant. Thus, even if the substrate and the blanket are separated at a constant speed, the progressing speed discontinuously changes when the locally formed detachment boundary lines DL are united. Furthermore, in addition, the speed changes at various positions, when locally viewed, in the process of changing the winding detachment boundary line DL into a straight line (the shape of the detachment boundary line changes due to a speed difference depending on the position). This could cause the damage of the pattern.

Even in these Comparative Examples, the detachment boundary line can be finally formed into a straight line by bringing the roller into contact with the substrate. However, in order to reliably achieve that effect, it is necessary to temporarily stop the detachment when the detachment progresses up to the contact position with the roller and then perform the detachment while moving the roller. Since the speed changes at this time, the damage of the pattern is caused after all. The damage in the effective region can be prevented if the roller is held in contact with the substrate outside the effective region in advance, but the size of the effective region is determined depending on how close to the substrate end part the roller can be brought and there is a possibility of narrowing the effective region due to a structural restriction.

Contrary to this, in the detaching process of this embodiment, the detachment boundary line DL in the form of a straight line perpendicular to the detaching direction is formed in the initial stage of the detachment as shown in FIG. 8C and moves in the detaching direction without changing the shape thereof even in the ongoing course of the process. Thus, the detaching speed is kept constant, also locally, from beginning to end and the damage of the pattern is prevented.

A main configuration in this embodiment for forming the detachment boundary line DL into a straight line in the initial stage of the detachment is to bend the blanket BL into the cylindrical or prismatic surface in the direction away from the substrate SB. On other hand, to bring the roller 521 into contact is a constituent element for moving the detachment boundary line DL at the constant speed while maintaining it as a straight line. In this sense, it is possible to form the straight detachment boundary line from the beginning on in this embodiment regardless of the position of the roller 521 in the initial stage.

As described above, in this embodiment, one end part of the blanket BL as one component of the laminated body as an object for detachment is bent into the cylindrical or prismatic surface in the direction away from the substrate SB as the other component in the initial stage of the detachment. This realizes the formation of the single and straight detachment boundary line DL on an end part of the adhering region where the both adhere. Then, the detachment is performed by moving the detachment boundary line DL at the constant speed while maintaining it as a straight line. Therefore, the detachment can be satisfactorily performed while the damage of the pattern associated with a variation in the detaching speed is prevented.

To deform the blanket BL into the cylindrical or prismatic surface, the laminated body is placed on the horizontal surface section 311 of the stage 310 having the straight ridge section E1 and a part of the blanket BL projecting from the ridge section E1 is pressed by the pressing member 321 in this embodiment. At this time, the pressing member 321 uniformly presses the blanket BL in a wide range extending in parallel to a ridge direction. This can prevent the local deflection of the blanket BL and stably and reliably cause the deformation into the cylindrical or prismatic surface.

As described above, in this embodiment, the blanket BL of the laminated body as an object for the detaching process corresponds to a “first plate-like body” of the invention and the substrate SB (or the plate) corresponds to a “second plate-like body” of the invention. Accordingly, the stage 310 in this embodiment functions as a “first holder” and a “stage” of the invention and the suction pads 122 function as a “second holder” of the invention. Further, the initial detaching block 320 functions as a “detachment starter” of the invention, whereas the elevating mechanism 523 for elevating the suction pad 122 functions as a “separator” of the invention. Further, the detachment boundary line DL corresponds to a “boundary line” of the invention.

Further, in this embodiment, the horizontal surface section 311 of the stage 310 functions as a “contact surface” of the invention and the pressing member 321 and the roller 521 respectively function as a “pressing member” and a “contactor” of the invention.

Further, in the detaching process (FIG. 5) of the invention, Steps S101 and S102 correspond to a “setting step”, and Step S104 corresponds to a “boundary line forming step” of the invention. Furthermore, Steps S105 to S108 correspond to a “detaching step” of the invention.

### <Modification of the First Embodiment>

Note that the invention is not limited to the above embodiment and various changes other than the aforementioned one can be made without departing from the gist thereof. For example, in the above embodiment, the laminated body formed by placing the substrate SB and the blanket BL one over the other is placed in the horizontal posture with the blanket BL located below. However, the posture of the substrate and the blanket is arbitrary without being limited to this.

For example, although the blanket BL is pressed down to be bent by the pressing member 321 in the form of a flat plate in the above embodiment, a pressing member in the form of a roller may be, for example, used instead of this. Further, although the stage 310 has a tapered shape continuous from the horizontal surface section 311 to the inclined surface section 312, it may be a stage having, for example, a step-like level difference. In this case, the pressing member preferably includes a stopper mechanism so as not to bend the blanket BL more than necessary.

For example, in the above embodiment, the annular groove 313 open to the atmospheric air is provided to prevent the surface state of the stage 310 from affecting the substrate SB and the pattern. However, the annular groove 313 is not an essential element and the appropriately managed positive or negative pressure may be supplied. Further, the shape of the groove is not limited to the annular shape and can be any arbitrary shape continuously or intermittently surrounding the outer side of the effective region.

Further, the holding of each of the substrate SB and the blanket BL is not limited to vacuum suction. For example, these may be mechanically or magnetically held. For example, an outer peripheral part can be mechanically pressed by a holding frame for the blanket BL. Further, although only one end part of the substrate SB is vacuum-sucked in the above embodiment, the entire substrate may be sucked or suction pads may be distributed and arranged at various positions of the substrate.

For example, a vacuum suction groove may be provided on the inclined surface section 312 of the stage 310 to suck the blanket BL bent by being pressed by the pressing member 321 and maintain the bent posture.

As described above, for example, the first holder may include a planar contact surface and another surface connected to the planar contact surface and hold the first plate-like body in a state where at least a part of a ridge between the planar contact surface and the other surface is a straight line having a length not shorter than the length of the first plate-like body in a direction of the ridge, the planar contact surface is brought into contact with a surface of the first plate-like body opposite to a surface adhering to the second plate-like body and one end part of the first plate-like body projects further outward than the ridge from the planar contact surface and the detachment starter may be configured to bend the first plate-like body at the outer side of the ridge in a first aspect of the detaching apparatus according to this invention.

Since a region of the first plate-like body held in contact with the planar contact surface is kept in a planar state in such a configuration, only one end part can be reliably bent by preventing bending in this region. Further, by bending the first plate-like body in a state held in contact with the straight ridge, the boundary line formed by bending can be reliably formed into a straight line.

For example, in the case of detaching two plate-like bodies adhering to each other and having different planar sizes, the one having a larger planar size out of these may be treated as the first plate-like body and the other as the second plate-like body, the first holder may cause a peripheral edge part of the first plate-like body not adhering to the second plate-like body to project to the outer side of the ridge and hold the peripheral edge part, and the detachment starter may be configured to include a pressing member for pressing the first plate-like body in a direction opposite to the second plate-like body by coming into contact with the peripheral edge part from the side of the second plate-like body. By pressing the one end part of the first plate-like body by the pressing member, the first plate-like body can be reliably deformed and partly detached from the second plate-like body.

In this case, the pressing member may be configured to uniformly come into contact with the first plate-like body in a direction parallel to the ridge. If a pressing force acting on the first plate-like body is uneven, the first plate-like body may be deformed in a wavy manner and may not be deformed into a cylindrical or prismatic surface. The boundary line formed by that becomes winding and cannot be a straight line. By applying the pressing force evenly along one direction, the first plate-like body can be bent into the cylindrical or prismatic surface and the boundary line can be reliably formed into a straight line. If the boundary line extends in a direction parallel to the ridge, it is more effective.

For example, in the case of detaching first and second plate-like bodies adhering via a pattern or a thin film carried in an effective region in a central part of the second plate-like body, the detachment starter preferably forms a boundary line outside the effective region. In such a configuration, even if the boundary line undulates in an initial stage before a straight boundary line is established, the undulating line is prevented from affecting the effective region. Specifically, the damage of the pattern or the like in the effective region is prevented.

In this case, for example, a contactor may be provided which comes into contact with the second plate-like body at a side opposite to the first plate-like body, and the contactor may be configured to come into contact with the second plate-like body uniformly outside the effective region and in the direction parallel to the boundary line. By doing so, it can be prevented that the boundary line reaches the effective region in the initial stage of the detachment.

Note that, in this case, the contactor may be moved in a direction away from the boundary line while being held in contact with the second plate-like body as the first and second plate-like bodies are separated. By doing so, the detachment can be caused to progress while an irregular movement of the boundary line is restricted by the contactor.

For example, the first holder may suck and hold the first plate-like body at the outer side of a position facing the effective region and the detachment starter may be configured to bend the first plate-like body at the outer side of the part sucked and held by the first holder. Since a position where the first plate-like body is deformed is limited to the outer side of the sucked and held position in such a configuration, deformation at the position facing the effective region is prevented. This can prevent the pattern and the like from being stressed or strained.

For example, the second holder may be configured to hold a peripheral edge part of the second plate-like body closest to the position where the boundary line is formed. By doing so, the separation of the first and second plate-like bodies can be reliably started by concentrating a stress near the boundary line and the boundary line can be reliably moved in an opposite direction from the peripheral edge of the second plate-like body held by the second holder.

For example, the separator may be configured to increase a distance between the first and second holders at a constant speed. By separating the first and second holders at the constant speed after the straight boundary line is formed, the constant detaching speed can be obtained in the entire adhering region.

Further, a detaching method according to this invention may include, prior to the boundary line forming step, the setting step of bringing the first plate-like body into contact with the flat surface section of the stage in a state where one end part of the first plate-like body projects further outward than the ridge of the flat surface section of the stage, and the one end part may be pressed in a direction opposite to the second plate-like body from a side opposite to the stage in the boundary line forming step.

In such a configuration, similarly to the detaching apparatus described above, the one end part of the first plate-like body can be deformed in a direction away from the second plate-like body, whereby the first and second plate-like bodies can be partly detached to form the detachment boundary line.

Further, in the case of detaching the first and second plate-like bodies adhering via a pattern or a thin film carried in the effective region in a central part of the principle surface of the second plate-like body, a region of the first plate-like body facing the effective region may be brought into contact with the flat surface section and, on the other hand, a part of the first plate-like body outside the region facing the effective region may be brought into contact with the ridge of the flat surface section, for example, in the setting step. This can prevent the boundary line from reaching the effective region before the detaching step is performed and limit the deformation of the first plate-like body only to the outside of the effective region.

For example, in the detaching step, the contactor may be relatively moved to a side opposite to the detached region with respect to the second plate-like body in synchronization with separating movements of the first and second plate-like bodies while the contactor extending in a direction perpendicular to a direction of the boundary line is brought into contact with a surface of the second plate-like body opposite to the first plate-like body. By doing so, the progress of the detachment can be stably managed while an irregular movement of the boundary line is restricted by the contactor.

### Second Embodiment

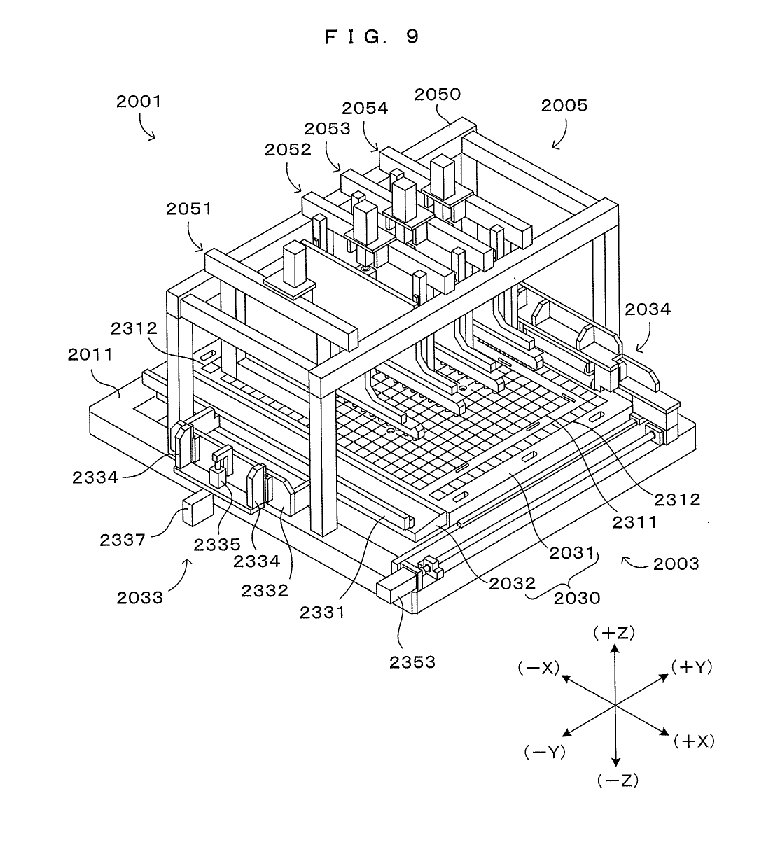

FIG. 9 is a perspective view showing a second embodiment of a detaching apparatus according to the present invention. In the second embodiment, XYZ orthogonal coordinate axes are set while dimensions of each component may be appropriately enlarged or reduced, similarly to the first embodiment in order to facilitate the understanding of the invention.

The detaching apparatus 2001 is, similarly to the detaching apparatus 1 (FIG. 1) of the first embodiment, an apparatus for detaching two plate-like bodies loaded in a state where principle surfaces adhere to each other. Specifically, in a pattern forming process including an applying step, a patterning step and a transferring step, this apparatus can be preferably applied for the purpose of separating a plate and a blanket or a substrate and the blanket. Of course, this apparatus may be used in applications other than this.

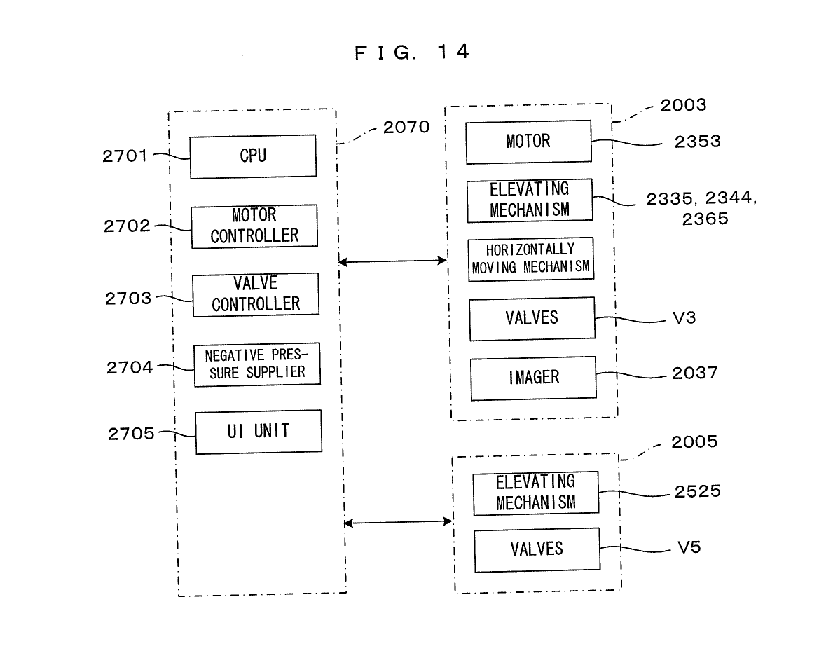

The detaching apparatus 2001 is so structured that a stage block 2003 and an upper suction block 2005 are respectively fixed onto a main frame 2011 attached to a housing. In FIG. 9, the housing is not shown to show an internal structure of the apparatus. Further, the detaching apparatus 2001 includes a control unit 2070 (FIG. 14) to be described later in addition to these blocks.

The stage block 2003 includes a stage 2030 on which a laminated body (hereinafter, referred to as a “work”) composed of a plate or a substrate and a blanket adhering to each other is to be placed, and the stage 2030 includes a horizontal stage section 2031 whose upper surface is a substantially horizontal flat surface and a tapered stage section 2032 whose upper surface is a flat surface inclined by several degrees (e.g. about 2°) with respect to a horizontal plane. An initial detaching unit 2033 is provided near an end part of the stage 2030 on the side of the tapered stage section 2032, i.e. on a (−Y) side. Further, a roller unit 2034 is provided to straddle the horizontal stage section 2031.

On the other hand, the upper suction block 2005 includes a support frame 2050 standing on the main frame 2011 and provided to cover an upper part of the stage block 2003 and a first suction unit 2051, a second suction unit 2052, a third suction unit 2053 and a fourth suction unit 2043 mounted on the support frame 2050. These suction units 2051 to 2054 are successively arranged in a (+Y) direction.

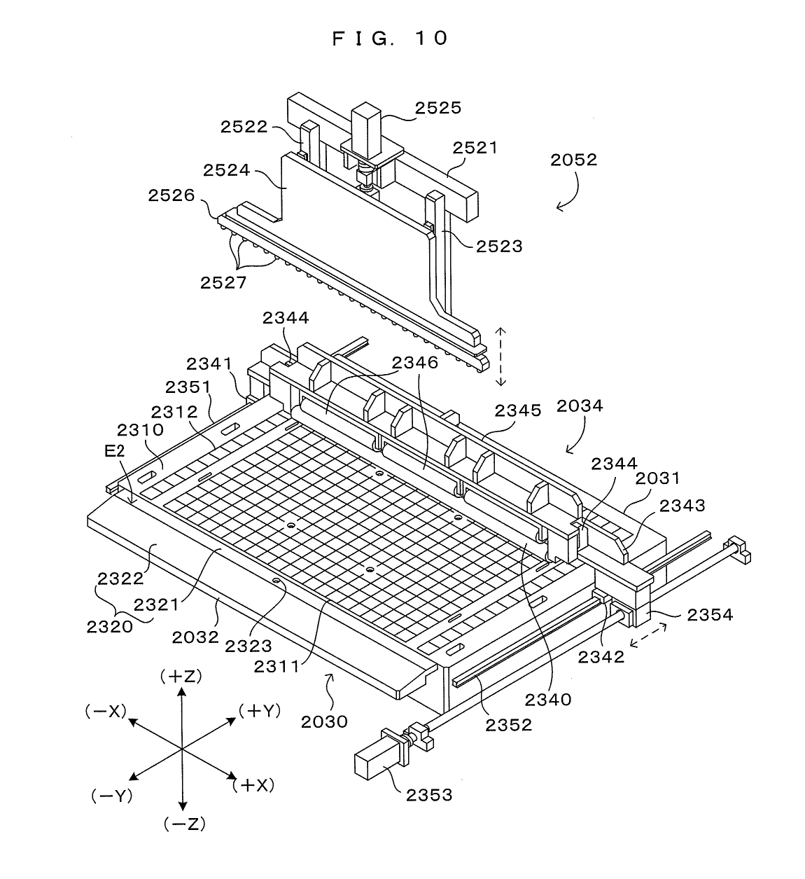

FIG. 10 is a perspective view showing a main configuration of the detaching apparatus. More specifically, FIG. 10 shows the structures of the stage 2030, the roller unit 2034 and the second suction unit 2052 out of the respective components of the detaching apparatus 2001. The stage 2030 includes the horizontal stage section 2031 whose upper surface 2310 is a substantially horizontal surface and the tapered stage section 2032 whose upper surface 2320 is a tapered surface. The upper surface 2310 of the horizontal stage section 2031 has a planar size slightly larger than that of the work to be placed thereon.

The tapered stage section 2032 is provided in close contact with a (−Y) side end part of the horizontal stage section 2031, and the upper surface 2320 thereof includes a horizontal surface 2321 and a tapered surface 2322. More specifically, out of the upper surface 2320 of the tapered stage section 2032, a part in contact with the horizontal stage section 2031 is the horizontal surface 2321 located at the same height (Z-direction position) as the upper surface 2310 of the tapered stage section 2032. On the other hand, at a (−Y) side of the horizontal surface 2321, the upper surface 2320 of the tapered stage section 2032 is the tapered surface 2322 inclined downward to recede downward, i.e. in a (−Z) direction with a distance from the horizontal stage section 2031 in a (−Y) direction. Thus, in the entire stage 2030, the horizontal surface of the upper surface 2310 of the horizontal stage section 2031 and the horizontal surface 2321 of the upper surface 2320 of the tapered stage section 2032 are continuous with each other to form an integral horizontal surface, and the tapered surface 2322 is connected to a (−Y) side end part of this horizontal surface. A ridge section E2 where the horizontal surface 2321 and the tapered surface 2322 are connected is in the form of a straight line extending in an X direction.

An imaging window 2323 is provided in a central part of the horizontal surface 2321 of the upper surface 2320 of the tapered stage section 2032 in the X direction. The imaging window 2323 is so structured that a transparent member is fitted in a through hole penetrating from the horizontal surface 2320 to the lower surface of the tapered stage section 2032, and the upper surface thereof is on the same plane as the horizontal surface 2321 of the tapered stage section 2032. Note that the imaging window only has to be structured to be able to optically observe the work placed on the stage 2030 from below and may be, for example, merely a through hole. The opening shape thereof is also arbitrary. Further, the entire tapered stage section 2032 or the entire horizontal surface 2321 may be made of a light transmissive material such as glass or quartz. In this case, it is not necessary to provide the imaging window.

Further, lattice-shaped grooves are engraved on the upper surface 2310 of the horizontal stage section 2031. More specifically, lattice-shaped grooves 2311 are provided in a central part of the upper surface 2310 of the horizontal stage section 2031 and grooves 2312 forming a rectangular shape with one missing side near the tapered stage section 2032 are provided on a peripheral edge part of the upper surface 2310 of the horizontal stage section 2031 to surround an area where the grooves 2311 are formed. These grooves 2311, 2312 are connected to a negative pressure supplier 2704 (FIG. 14) to be described later via control valves and function as suction grooves for sucking and holding the work placed on the stage 2030 by being supplied with a negative pressure. Since two types of the grooves 2311, 2312 are not connected on the stage and connected to the negative pressure supplier 2704 via the control valves independent of each other, suction using only one type of the grooves is possible in addition to suction using the both types of the grooves.

The roller unit 2034 is provided to straddle the thus configured stage 2030. Specifically, a pair of guide rails 2351, 2352 extend in the Y direction along opposite end parts of the horizontal stage section 2031 in the X direction, and these guide rails 2351, 2352 are fixed to the main frame 2011. The roller unit 2034 is slidably attached to the guide rails 2351, 2352.

The roller unit 2034 includes sliders 2341, 2342 respectively slidably engaged with the guide rails 2351, 2352. A lower angle 2343 extending in the X direction is provided to straddle an upper part of the stage 2030 in such a manner as to connect these sliders 2341, 2342. An upper angle 2345 is attached to the lower angle 2343 via appropriate elevating mechanisms 2344 movably upward and downward. A cylindrical detaching roller 2340 extending in the X direction is rotatably attached to the upper angle 2345.

When the upper angle 2345 is moved downward, i.e. in a (−Z) direction by the elevating mechanisms 2344, the lower surface of the detaching roller 2340 comes into contact with the upper surface of the work placed on the stage 2030. On the other hand, in a state where the upper angle 2345 is positioned at an upper position, i.e. a position in a (+Z) direction by the elevating mechanisms 2344, the detaching roller 2340 is separated upward from the upper surface of the work. A backup roller 2346 for suppressing the deflection of the detaching roller 2340 is rotatably attached to the upper angle 2345 and ribs for preventing the deflection of the upper angle 2345 itself are appropriately provided on the upper angle 2345. The detaching roller 2340 and the backup roller 2346 do not have a drive source and freely rotate.

The roller unit 2034 is made movable in the Y direction by a motor 2353 attached to the main frame 2011. More specifically, the lower angle 2343 is coupled, for example, to a ball screw mechanism 2354 as a translation mechanism for translating a rotational movement of the motor 2353 into a linear movement. When the motor 2353 rotates, the lower angle 2343 moves in the Y direction along the guide rails 2351, 2352. Thus, the roller unit 2034 moves in the Y direction. A movable range of the detaching roller 2340 associated with the movement of the roller unit 2034 is up to the vicinity of the (−Y) side end part of the horizontal stage section 2031 in the (−Y) direction and up to a position outwardly of a (+Y) side end part of the horizontal stage section 2031 in the (+Y) direction, i.e. a position further toward the (+Y) side.

Next, the configuration of the second suction unit 2052 is described. Note that all the first to fourth suction units 2051 to 2054 have the same structure. Here, the structure of the second suction unit 2052 is representatively described. The second suction unit 2052 includes a beam member 2521 extending in the X direction and fixed to the support frame 2050, and a pair of column members 2522, 2523 extending vertically downward, i.e. in the (−Z) direction are attached to the beam member 2521 at positions different in the X direction. A plate member 2524 is attached to the column members 2522, 2523 movably upward and downward via guide rails, which are hidden in FIG. 10, and the plate member 2524 is driven upward and downward by an elevating mechanism 2525 composed of a motor and a translation mechanism (e.g. ball screw mechanism).

A pad support member 2526 in the form of a bar extending in the X direction is attached to a lower part of the plate member 2524, and a plurality of suction pads 2527 are arranged at equal intervals in the X direction on the lower surface of this pad support member 2526. Although the second suction unit 2052 is shown in a state moved upward from an actual position in FIG. 10, the suction pads 2527 can be lowered to a position very close to the upper surface 2310 of the horizontal stage section 2031 when the plate member 2524 is moved downward by the elevating mechanism 2525. In this way, the suction pads 2527 come into contact with the upper surface of a work in a state where the work is placed on the stage 2030. A negative pressure from the negative pressure supplier 2704 to be described later is applied to each suction pad 2527, whereby the upper surface of the work is sucked and held.

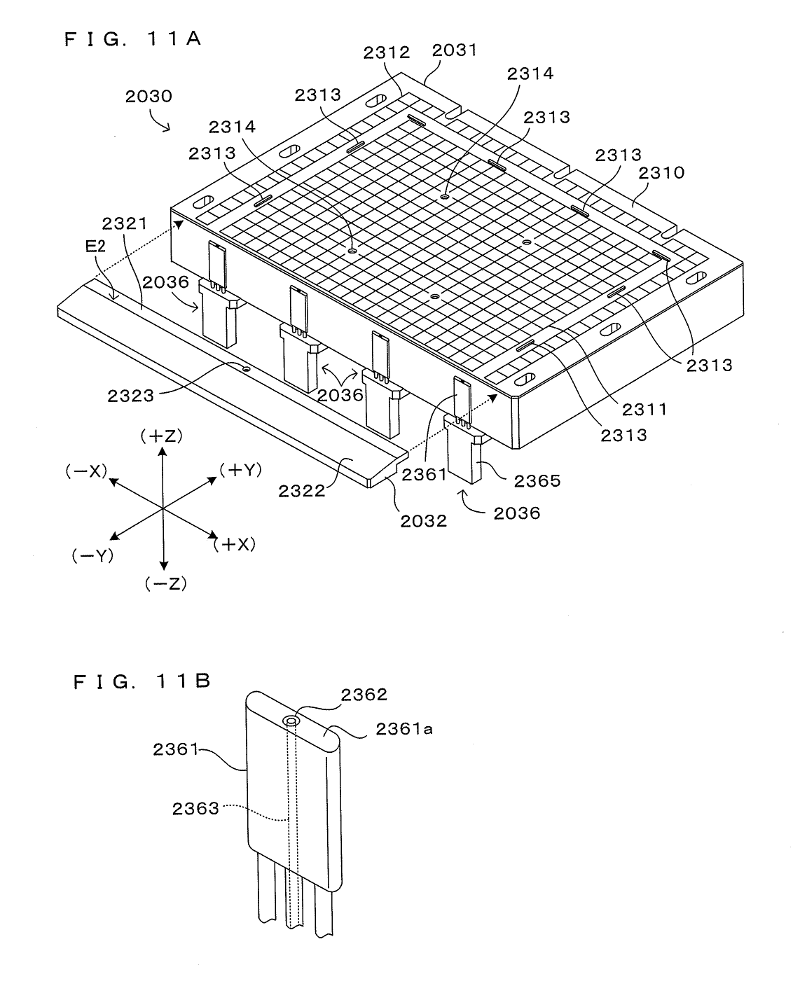

FIGS. 11A and 11B are perspective views showing a more detailed configuration of the stage. As shown in FIG. 11A, the horizontal stage section 2031 and the tapered stage section 2032 of the stage 2030 are separately formed and separable. The tapered stage section 2032 is made horizontally movable toward and away from the horizontal stage section 2031 by an unillustrated horizontally moving mechanism. The tapered stage section 2032 adheres to a side surface of the horizontal stage section 2031, whereby the horizontal stage section 2031 and the tapered stage section 2032 integrally function as the stage 2030.

Besides the suction grooves 2311, 2312 described above, openings 2313, 2314 having different shapes are provided on the upper surface 2310 of the horizontal stage section 2031. More specifically, a plurality of elliptical first openings 2313 are distributed and arranged at a plurality of positions of a flat part between the suction grooves 2311 and the suction grooves 2312 on the upper surface 2310 of the horizontal stage section 2031. Further, substantially circular second openings 2314 are provided at four positions separated from each other in a central part of the upper surface 2310 of the horizontal stage section 2031. Both the first openings 2313 and the second openings 2314 are not connected to the suction grooves 2311, 2312 on the upper surface 2310 of the horizontal stage section 2031. Thus, the suction grooves 2311 are divided around the second openings 2314.

On the other hand, four main lifters 2036 are juxtaposed in the X direction on a side where the tapered stage section 2032 is provided, i.e. on the (−Y) side surface of the horizontal stage section 2031. The structures of these main lifters 2036 are identical to each other. Each main lifter 2036 includes a lifter pin 2361 finished into a thin plate to extend along the side surface of the horizontal stage section 2031 and an elevating mechanism 2365 for supporting the lift pin 2361 from below and moving this upward and downward in the vertical direction (Z direction) in response to a drive signal from the control unit 2070 (FIG. 14). The elevating mechanisms 2365 are fixed to the bottom surface of the horizontal stage section 2031.

FIG. 11B shows a schematic structure of the lifter pin 2361. As shown in FIG. 11B, an upper surface 2361a of the lifter pin 2361 is finished into a substantially flat surface. A suction pad 2362 is provided in a central part of the upper surface 2361a and communicates with a negative pressure supply path 2363 penetrating through the interior of the lifter pin 2361. The negative pressure supply path 2363 is connected to the negative pressure supplier 2704 (FIG. 14) to be described later via a control valve.

Similarly structured main lifters 2036 are provided for the plurality of first openings 2313 perforated on the upper surface 2310 of the horizontal stage section 2031 in a one-to-one correspondence. Specifically, an elevating mechanism 2365 is attached to the lower end of a through hole penetrating from each first opening 2313 to the bottom surface of the horizontal stage section 2031, and a lifter pin 2361 is inserted into the through hole communicating with each opening 2313.

Each main lifter 2036 makes the same movement in accordance with a drive signal from the control unit 2070. Specifically, each lifter pin 2361 can be positioned at each of a lower position where the upper end thereof is located below the upper surface 2310 of the horizontal stage section 2031 and an upper position where the upper end thereof projects further upward than the upper surface 2310 of the horizontal stage section 2031, and the lifter pins 2361 move upward and downward at once between the upper position and the lower position in accordance with a drive signal from the control unit 2070. At the upper position where the upper end of each lifter pin 2361 is positioned to project further upward than the upper surface 2310 of the horizontal stage section 2031, the work can be supported in a state separated from the stage 2030 by bringing the upper surface 2361a of each lifter pin 2361 into contact with the lower surface of the work placed on the stage 2030.

Further, unillustrated sub-lifters are arranged in the second openings 2314 perforated in the central part of the upper surface 2310 of the horizontal stage section 2031 where the suction grooves 2311 are arranged. Similarly to the main lifters 2036, each sub-lifter includes a lifter pin and an elevating mechanism for moving the lifter pin upward and downward, and can auxiliarily support the work by causing the lifter pins to project further upward than the upper surface 2310 of the horizontal stage section 2031 in accordance with a drive signal from the control unit 2070. The upper surface of the lifter pin of the sub-lifter has a disk shape smaller than the upper surface 2361a of the lifter pin 2361 of the main lifter 2036, and the second opening 2314 is shaped to correspond to this.

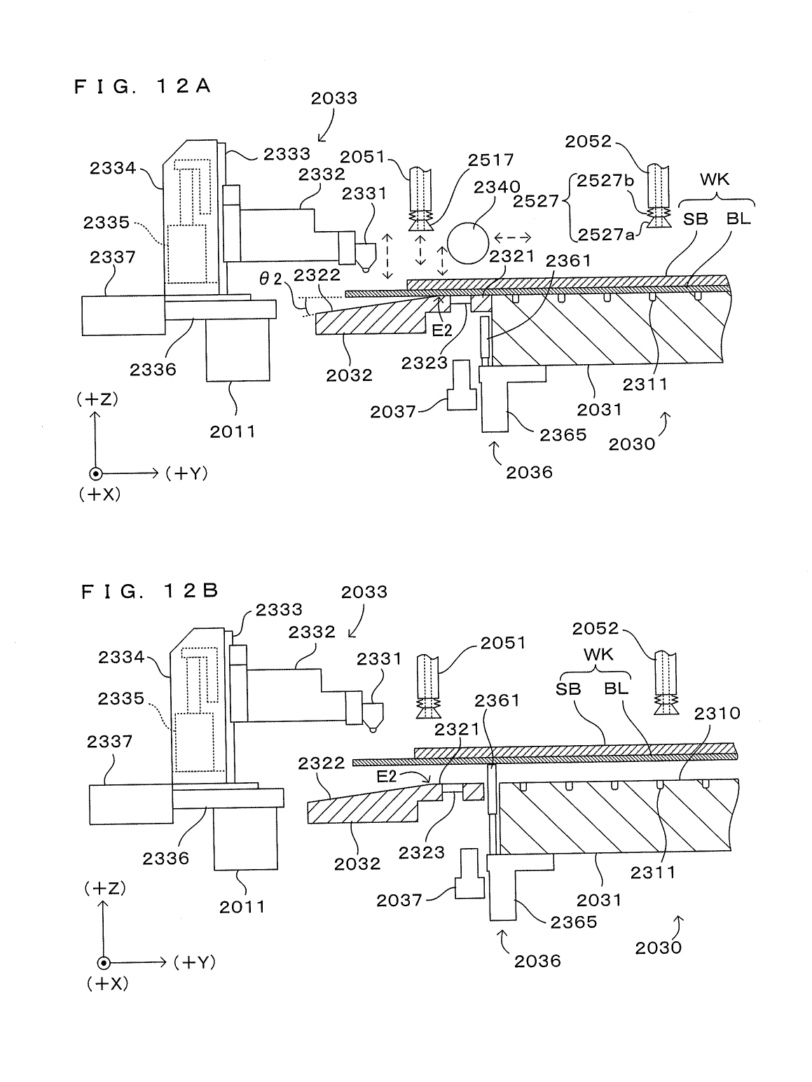

FIGS. 12A and 12B are side views showing the structure of the initial detaching unit and a positional relationship of each component. First, the structure of the initial detaching unit 2033 is described with reference to FIGS. 9, 12A and 12B. As shown in FIG. 12A, the initial detaching unit 2033 includes a pressing member 2331 in the form of a bar extending in the X direction above the tapered stage section 2032 and supported by a support arm 2332. The support arm 2332 is attached to column members 2334 movably upward and downward via vertically extending guide rails 2333. By the operation of an elevating mechanism 2335, the support arm 2332 moves upward and downward relative to the column members 2334. The column members 2334 are supported by a base 2336 attached to the main frame 2011 and the Y-direction positions of the column members 2334 on the base 2336 can be adjusted within a predetermined range by a position adjusting mechanism 2337.

A work WK as an object for detachment is placed on the stage 2030 composed of the horizontal stage section 2031 and the tapered stage section 2032. A work in a patterning process is a laminated body composed of a plate and a blanket adhering via a thin film made of a pattern forming material. On the other hand, a work in a transferring process is a laminated body composed of a substrate and a blanket adhering via a patterned pattern. Although a detaching operation of the detaching apparatus 2001 when a laminated body of a substrate SB and a blanket BL in the transferring process is the work WK is described below, detachment can be performed by a similar method also when a laminated body of a plate and a blanket is a work.

In the work WK, the blanket BL has a larger planar size than the substrate SB. The substrate SB adheres to a substantially central part of the blanket BL. The work WK is placed on the stage 2030 with the blanket BL arranged below and the substrate SB arranged above. At this time, as shown in FIG. 12A, a (−Y) side end part of the substrate SB of the work WK is located substantially above a boundary between the horizontal surface and the tapered surface of the stage 2030, i.e. the ridge section E2 of the boundary between the horizontal surface 2321 and the tapered surface 2322 of the tapered stage section 2032. More specifically, the work WK is so placed on the stage 2030 that the (−Y) side end part of the substrate SB is shifted slightly toward the (−Y) side than the ridge section E2. Accordingly, a part of the blanket BL outside the substrate SB in the (−Y) direction is arranged to project above the tapered surface 2322 of the tapered stage section 2032, and a clearance is formed between the lower surface of the blanket BL and the tapered surface 2322. An angle θ2 formed between the lower surface of the blanket BL and the tapered surface 2322 is about several degrees (2° in this embodiment) and is the same as a taper angle of the tapered stage section 2032.

The suction grooves 2311 are provided on the horizontal stage section 2031 and the lower surface of the blanket BL is sucked and held. More specifically, the suction grooves 2311 suck the lower surface of the blanket BL in contact with a lower part of the substrate SB. On the other hand, as shown in FIG. 11A, the other suction grooves 2312 are provided to surround the suction grooves 2311 and suck the lower surface of the blanket BL outside the substrate SB. The suction grooves 2311, 2312 can effect and release suction independently of each other, and the blanket BL can be strongly sucked using both types of the suction grooves 2311, 2312. On the other hand, the damage of the pattern due to the deflection of the blanket BL caused by suction can be prevented by effecting suction only using the suction grooves 2312 on the outer side without sucking the central part of the blanket BL where the pattern is effectively formed. By independently controlling the supply of the negative pressure to the suction grooves 2311 in the central part and the suction grooves 2312 in the peripheral edge part, a mode for sucking and holding the blanket BL can be switched according to a purpose.

In this way, the first to fourth suction units 2051 to 2054 and the detaching roller 2340 of the roller unit 2034 are arranged above the work WK sucked and held on the stage 2030. Out of the four suction units, two suction units 2051, 2052 on the (−Y) side are shown in FIG. 12A. As described above, the plurality of suction pads 2527 are juxtaposed in the X direction on the lower part of the second suction unit 2052. More specifically, the suction pad 2527 is integrally formed of a flexible and elastic material such as rubber and silicon resin and the lower surface thereof includes a sucking portion 2527a for sucking the upper surface of the work WK (more specifically, the upper surface of the substrate SB) by coming into contact therewith and a bellows portion 2527b stretchable in the vertical direction (Z direction). Suction pads provided on the other suction units 2051, 2053 and 2054 also have the same structure. The suction pads provided on the first suction units 2051 are denoted by 2517 to be distinguished from the suction pads 2527 of the second suction unit 2052.

The first suction unit 2051 is provided above the ridge section E2 and sucks the upper surface of the (−Y) side end part of the substrate SB when being lowered. On the other hand, the fourth suction unit 2054 (FIG. 9) arranged on the most (+Y) side is provided above the (+Y) side end part of the substrate SB placed on the stage 2030 and sucks the upper surface of the (+Y) side end part of the substrate SB when being lowered. The second and third suction units 2052, 2053 are appropriately distributed and arranged between these, and the suction pads 2527 and the like provided on the respective suction units 2051 to 2054 can be, for example, arranged substantially at equal intervals in the Y direction. These suction units 2051 to 2054 can vertically move and effect and release suction independently of each other.

The detaching roller 2340 moves toward and away from the substrate SB in the vertical direction and horizontally moves along the substrate SB by moving in the Y direction. In a lowered state, the detaching roller 2340 horizontally moves while rolling in contact with the upper surface of the substrate SB. The position of the detaching roller 2340 when it moves to the most (−Y) side is a position closest to the suction pads 2517 of the first suction unit 2051 on the (+Y) side. To enable the arrangement to such a close position, the first suction unit 2051 having the same structure as the second suction unit 2052 shown in FIG. 10 is attached to the support frame 2050 in a posture opposite to those of the other second to fourth suction units 2052 to 2054 as shown in FIG. 9.

The Y-direction position of the initial detaching unit 2033 is so adjusted that the pressing member 2331 is located above the blanket BL projecting above the tapered stage section 2032. By lowering the support arm 2332, the lower end of the pressing member 2331 is lowered to press the upper surface of the blanket BL. The tip of the pressing member 2331 is formed of an elastic material so that the pressing member 2331 does not damage the blanket BL at this time.

As described above, the main lifters 2036 are provided on the (−Y) side surface of the horizontal stage section 2031. A part below the horizontal surface 2321 of the tapered stage section 2032 is cut out so that the lifter pins 2361 retracted to the lower position and the tapered stage section 2032 do not interfere.

Further, an imager 2037 including an imaging element such as a CCD sensor or a CMOS sensor and an imaging optical system for imaging in an upward direction are provided at a position right below the imaging window 2323 provided on the horizontal surface 2321 of the tapered stage section 2032. The imager 2037 is fixed to any one of the horizontal stage section 2031, the tapered stage section 2032 and the main frame 2011. The imager 2037 images the work WK facing the imaging window 2323 from below via the imaging window 2323, and transmits obtained image data to the control unit 2070 (FIG. 14).

Note that the tapered stage section 2032 is made movable in the Y direction by the unillustrated horizontally moving mechanism. As shown in FIG. 12A, the tapered stage section 2032 is in contact with the side surface of the horizontal stage section 2031 and functions as the integral stage 2030 in a state positioned at a (+Y) side position by the horizontally moving mechanism. On the other hand, in a state positioned at a (−Y) side position by the horizontally moving mechanism, the tapered stage section 2032 is separated from the horizontal stage section 2031 to form a clearance therebetween and the lifter pins 2361 of the main lifters 2036 attached to the (−Y) side surface of the horizontal stage section 2031 move upward and downward through this clearance as shown in FIG. 12B.

FIG. 12B shows a case where the imager 2037 is fixed to the horizontal stage section 2031 or the main frame 2011, and the imager 2037 does not move with the movement of the tapered stage section 2032. On the other hand, if the imager 2037 is fixed to the tapered stage section 2032, the imager 2037 also moves in the Y direction together with the movement of the tapered stage section 2032. As described later, the imager 2037 may be in either one of these modes since it performs imaging in a state shown in FIG. 12A where the horizontal stage section 2031 and the tapered stage section 2032 are connected.

In a state where the plurality of lifter pins 2361 provided on the horizontal stage section 2031 project further upward than the stage upper surface 2310 in this way, the work WK can be supported in a state separated from the stage upper surface 2310. In loading the work WK into the detaching apparatus 2001 from the outside, the work WK can be received by causing the lifter pins 2361 to project to the upper position. After the work WK is received in this way, the lifter pins 2361 are lowered to be retracted to a position below the stage upper surface 2310, whereby the work WK is transferred to the stage 2030. On the other hand, also the blanket BL remaining on the stage 2030 after the detaching process for the work WK is finished can be transferred to the outside by being lifted from the stage 2030 by the lifter pins 2361.

In these cases, the lower surface of the blanket BL can be sucked and held by supplying the negative pressure to the suction pad 2362 provided on each lifter pin 2361. Further, by actuating the sub-lifters according to need, the deflection of the central part of the work WK or the blanket BL can be suppressed.

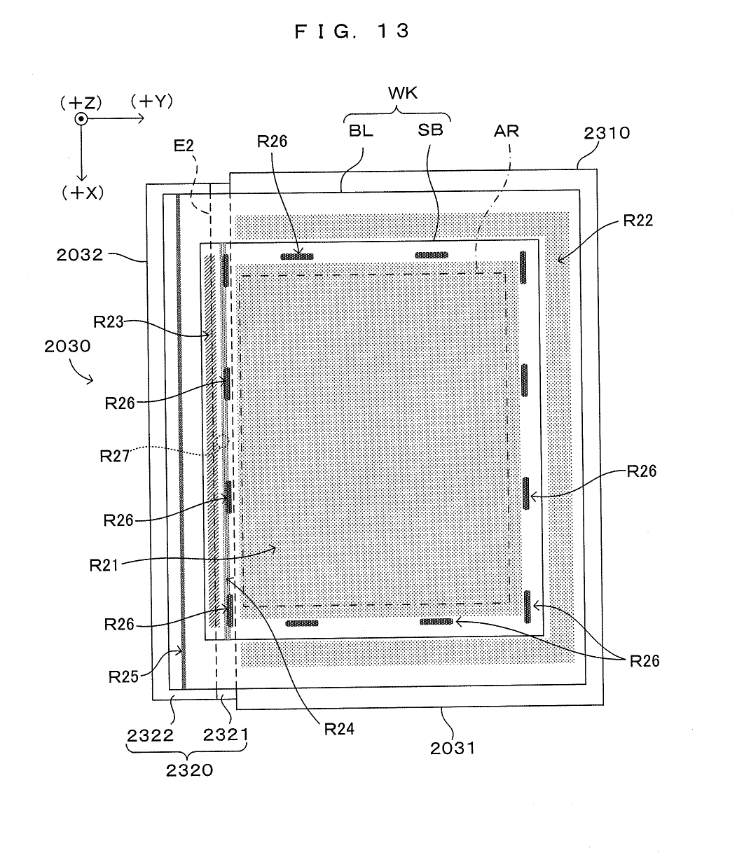

FIG. 13 is a view showing a positional relationship between the stage and the work placed thereon. In the work WK composed of the adhering substrate SB and blanket BL, the blanket BL has a larger planar size than the substrate SB. Thus, the entire surface of the substrate SB is facing the blanket BL, whereas the central part of the blanket BL is facing the substrate SB and a peripheral edge part is a margin part not facing the substrate SB. A pattern is effectively transferred to the central part excluding a peripheral edge part out of the surface area of the substrate SB, thereby setting an effective region AR that functions as a device. Thus, the detaching apparatus 2001 aims to detach the substrate SB and the blanket BL without damaging the pattern transferred to the effective region AR of the substrate SB from the blanket BL.

The work WK is so placed on the stage 2030 that the entire effective region AR of the substrate SB is located on the upper surface 2310 of the horizontal stage section 2031. On the other hand, outside the effective region AR, the (−Y) side end part of the substrate SB is positioned at a position slightly projecting toward the (−Y) side from the ridge section E2 on the boundary between the horizontal surface and the tapered surface of the stage 2030.

A dotted region R21 in FIG. 13 shows a region where the blanket BL is sucked by the suction grooves 2311. The region R21 sucked by the suction grooves 2311 covers the entire effective region AR. Further, the region R22 shows a region where the blanket BL is sucked by the suction grooves 2312. The suction grooves 2312 suck the blanket BL outside the effective region AR. Thus, for example, in a mode for sucking the blanket BL only by the suction grooves 2312, it is avoided that the pattern in the effective region AR is affected by suction.

Further, regions R26 show lower surface regions of the blanket BL, with which the lifter pins 2361 of the main lifters 2036 come into contact. The lifter pins 2361 come into contact with the lower surface of the blanket BL in regions of the work WK where the substrate SB and the blanket BL overlap and which are outside the effective region AR. This can prevent a pressing force from being applied to the pattern or the like in the effective region AR in supporting. Further, since the work WK is supported by the rigidity of the substrate SB and that of the blanket BL, the work WK can be reliably supported even if it is large and heavy. Other regions R23, R24 and R27 shown in FIG. 13 are described when operations are described later.

FIG. 14 is a block diagram showing the electrical configuration of the detaching apparatus. Each apparatus component is controlled by the control unit 2070. The control unit 2070 includes a CPU 2701 in charge of the operation of the entire apparatus, a motor controller 2702 for controlling motors provided in the respective components, a valve controller 2703 for controlling valves provided in the respective components, the negative pressure supplier 2704 for generating a negative pressure to be supplied to each component, and a user interface (UI) unit 2705 for receiving an operation input from a user and notifying a state of the apparatus to the user. Note that the control unit 2070 may not include the negative pressure supplier if a negative pressure supplied from the outside such as factory power usage is usable.

The motor controller 2702 controls the drive of the motors including the motor 2353 and the elevating mechanisms 2335, 2344 and 2365 provided in and on the stage block 2003, the horizontally moving mechanism, and the elevating mechanisms 2525 provided on the respective elevating mechanisms 2051 to 2054 of the upper suction block 2005. Note that although the motors are representatively described as drive sources for the respective movable components here, there is no limitation to this and various actuators such as air cylinders, solenoids and piezoelectric elements may be used as drive sources depending on the intended use.

The valve controller 2703 controls valves V3 and V5. The valves V3 are provided on a piping route extending from the negative pressure supplier 2704 to the suction grooves 2311, 2312 provided on the horizontal stage section 2031 and the suction pads 2362 provided on the lifter pins 2361 and configured to individually supply a predetermined negative pressure to these suction grooves and suction pads. The valves V5 are provided on a piping route extending from the negative pressure supplier 2704 to the suction pads 2517 and the like of the respective suction units 2051 to 2054 and configured to supply a predetermined negative pressure to the respective suction pads 2517 and the like.

Further, the control unit 2070 controls the imager 2037 provided in the stage block 2003 to perform a necessary imaging operation, and receives and processes image data obtained by the imager 2037. The imager 2037 images the lower surface of the blanket BL via the imaging window 2323 provided on the tapered stage section 2032. The control unit 2070 controls the progress of a detaching operation described below based on imaged images.

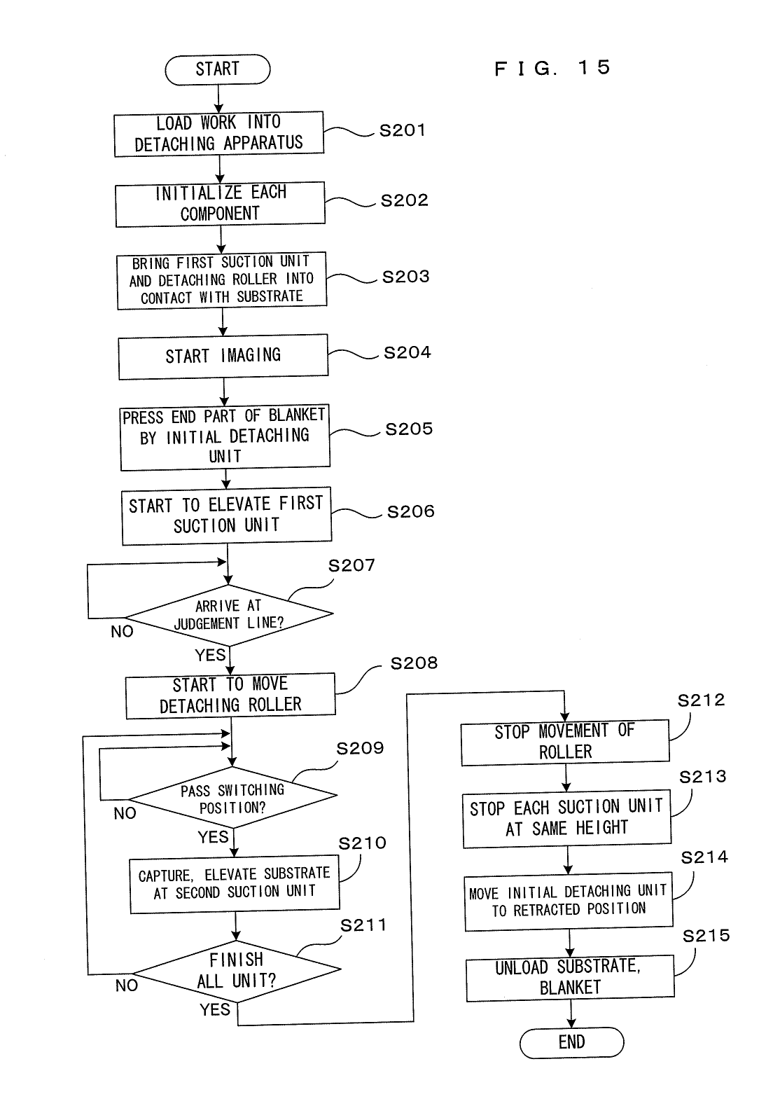

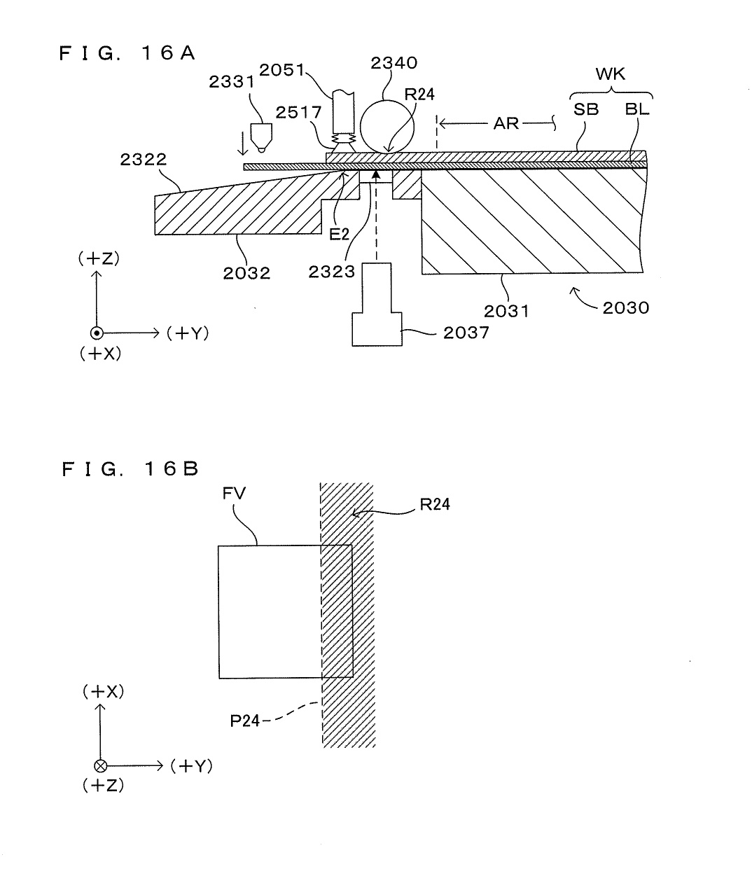

Next, the detaching operation by the detaching apparatus 2001 configured as described above is described with reference to FIGS. 15 to 18D. FIG. 15 is a flow chart showing a detaching process. Further, FIGS. 16A, 16B, 17A to 17C and 18A to 18D are views showing a positional relationship of each component in each stage of the process and diagrammatically showing the progress of the process. This detaching process is performed by the CPU 2701 executing a process program stored in advance to control each component.

First, a work WK is loaded to the above position on the stage 2030 by an operator, an external conveyor robot or the like (Step S201). Then, the apparatus is initialized and each component of the apparatus is set to a predetermined initial state (Step S202). In the initial state, the work WK is sucked and held by the suction grooves 2311 and/or the suction grooves 2312. Further, the pressing member 2331 of the initial detaching unit 2033, the detaching roller 2340 of the roller unit 2034 and the suction pads 2517 and the like of the first and fourth suction units 2051 to 2054 are all separated from the work WK. Further, the detaching roller 2340 is at a position closest to the (−Y) side in the movable range thereof.

In this state, the first suction unit 2051 and the detaching roller 2340 are lowered and brought into contact with the upper surface of the work WK (Step S203). At this time, as shown in FIG. 16A, the suction pads 2517 of the first suction unit 2051 suck the upper surface of a (−Y) side end part of a substrate SB and the detaching roller 2340 is in contact with the upper surface of the substrate SB at a position adjacent to the suction pads 2517 on the (+Y) side. Note that a downward arrow drawn near the pressing member 2331 in FIG. 16A means that the pressing member 2331 moves in a direction of this arrow in a subsequent step from the state shown in FIG. 16A. The same holds true for figures to be described below.

A region R23 shown in FIG. 13 shows a region where the substrate SB is sucked by the first suction unit 2051 at this time, and a region R24 shows a contact nip region formed by the contact of the detaching roller 2340 with the substrate SB. As shown in FIG. 13, the suction unit 2051 sucks and holds the (−Y) side end part of the substrate SB, whereas the detaching roller 2340 is in contact with the substrate SB in the region R24 adjacent to the suction region R23 by the first suction unit 2051 on the (+Y) side. The contact nip region R24 where the detaching roller 2340 is in contact is a position outside the effective region AR, i.e. closer to the (−Y) side than the effective region AR, and on the horizontal surface closer to the (+Y) side than the ridge section E2 of the stage 2030. Thus, the inside of the effective region AR is neither sucked by the first suction unit 2051 nor pressed by the detaching roller 2340.

Subsequently, the imaging by the imager 2037 is started (Step S204). Thereafter, the imager 2037 transmits an imaged image to the control unit 2070 in real time at any time. The imager 2037 itself may operate before this. A region R27 shown in FIG. 13 shows a region of the horizontal surface 2321 of the tapered stage section 2032 where the imaging window 2323 is provided. As shown in FIG. 13, the region R27 is the region where the imaging window 2323 is provided while the contact nip region R24 is the region which is formed by the detaching roller 2340, and the two regions R24 and R27 partly overlap each other. In other words, the position of the imaging window 2323 and the initial position of the detaching roller 2340 are set in advance to achieve such an arrangement.

As shown in FIG. 16A, the imager 2037 is provided at a position right below the imaging window 2323 and images an upper side via the imaging window 2323. As described above, a part of a contact nip formed by the contact of the detaching roller 2340 with the substrate SB is facing the imaging window 2323. As shown in FIG. 16B, at least a part of the contact nip region R24, preferably a (−Y) side end part P24 thereof is included in an imaging visual field FV when the imager 2037 images the lower surface of the blanket BL.

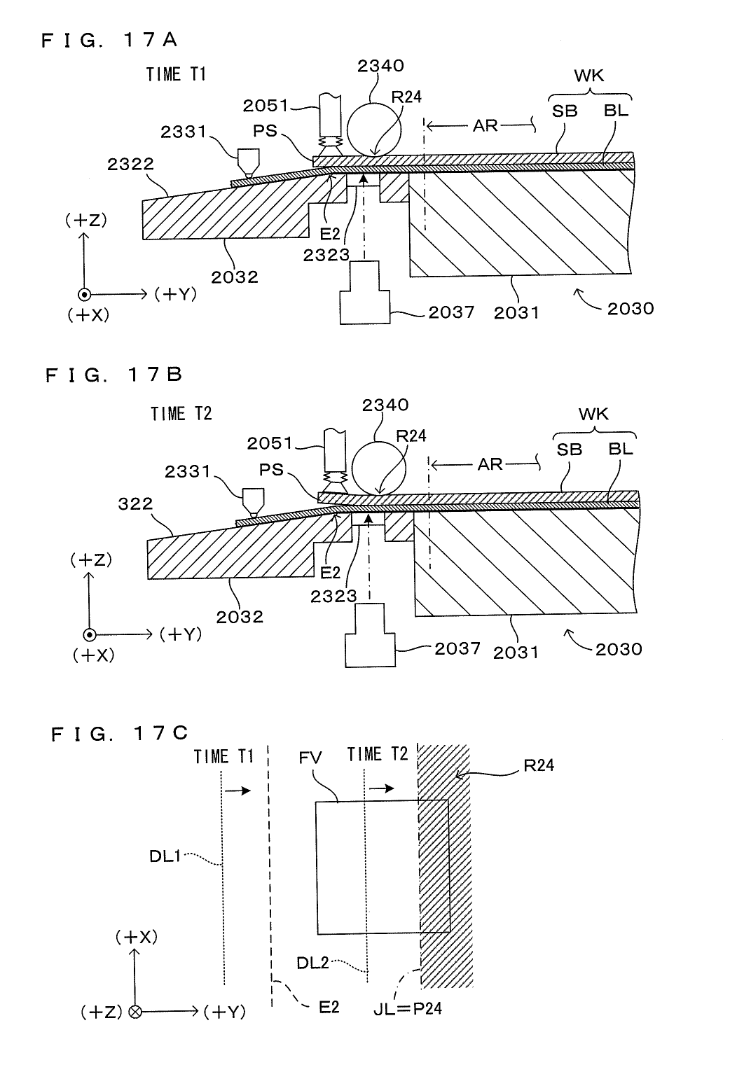

Referring back to FIG. 15, the initial detaching unit 2033 is subsequently actuated to lower the pressing member 2331 and press an end part of the blanket BL (Step S205). The end part of the blanket BL projects above the tapered surface 2322 of the tapered stage section 2032 and there is a clearance between the lower surface thereof and the tapered surface 2322. Thus, the end part of the blanket BL is bent downward along the tapered surface 2322 by the pressing member 2331 pressing the end part of the blanket BL downward as shown in FIG. 17A. As a result, a (−Y) side end part PS of the substrate SB sucked and held by the first suction unit 2051 and the blanket BL are separated, whereby detachment is started. The pressing member 2331 is in the form of a bar extending in the X direction and the length thereof in the X direction is set to be longer than the blanket BL. Thus, as shown in FIG. 13, a contact region R25 where the pressing member 2331 is in contact with the blanket BL extends straight from a (−X) side end part to a (+X) side end part of the blanket BL. By doing so, the blanket BL can be bent into a cylindrical or prismatic surface and a boundary line between a detached region where the substrate SB and the blanket BL are already detached and an undetached region where they are not detached yet, i.e. a detachment boundary line can be formed into a straight line.

In a state where the detachment from the substrate end part PS is started in this way, the elevation of the first suction unit 2051 is started (Step S206). This causes the end part PS of the substrate SB sucked and held by the first suction unit 2051 to be further separated from the blanket BL as shown in FIG. 17B and, associated with this, the detachment boundary line moves in the (+Y) direction and the detachment progresses. Specifically, a detachment progressing direction in this embodiment is the (+Y) direction.

FIG. 17C is a view diagrammatically showing a relationship between a movement of the detachment boundary line during this time and an image imaged by the imager 2037. A detachment boundary line DL1 at a time T1 illustrated in FIG. 17A, i.e. at a time immediately after the start of the detachment between the substrate SB and the blanket BL by the pressing of the pressing member 233 is located closer to the (−Y) side than the ridge section E2 of the stage 2030 as shown in FIG. 17C and does not necessarily fall within the imaging visual field FV.

A (−Y) side relative to the detachment boundary line, i.e. an upstream side in the detachment progressing direction is a detached area where the substrate SB having adhered to the upper surface of the blanket BL is already detached, and a clearance is formed between the both and a surrounding atmosphere flows thereinto. On the other hand, a (+Y) side relative to the detachment boundary line, i.e. a downstream side in the detachment progressing direction is an undetached area where the substrate SB still adheres to the upper surface of the blanket BL. In the imaging via the blanket BL, there is a large luminance difference between the detached region and the undetached region due to differences in color tone and refractive index between the substrate SB and the surrounding atmosphere, wherefore the detachment boundary line can be easily optically detected.

To this end, the blanket BL is light-transmissive to allow at least a part of incident light to transmit. In the control unit 2070, the position of the detachment boundary line can be detected, for example, by detecting an edge having a large luminance change in an image. Note that the contact nip region R24 only has to have a known positional relationship between the position thereof and the imaging visual field FV and needs not necessary be detectable from an image.

Thereafter, at a time T2 illustrated in FIG. 17B, i.e. at a time at which the pull-up of the substrate end part PS is started and the detachment boundary line moves toward the (+Y) side, the detachment boundary line DL2 falls within the imaging visual field FV. This indicates that the detachment has progressed up to a position right above the imaging window 2323. Further, the substrate SB is pulled up and the detachment boundary line moves and finally reaches the contact nip region R24 by the detaching roller 2340.

If a movement of the detaching roller 2340 in the (+Y) direction is started at this timing, the detachment boundary line further moves in the (+Y) direction while the movement thereof is restricted by the detaching roller 2340 thereafter. That is, the detachment progresses while being managed by the movement of the detaching roller 2340.

At this time, the detachment boundary line neither enters the contact nip region R24 nor further moves in the (+Y) beyond this region. Accordingly, if there is a time lag between the arrival of the detachment boundary line at the contact nip region R24 and the start of the movement of the detaching roller 2340, the progress of the detachment is stopped during that time and is resumed together with the start of the movement of the detaching roller 2340. This causes a variation in a detaching speed. This causes a damage on the pattern and the like. Further, by forcibly pulling up the substrate SB pressed by the detaching roller 2340, the substrate SB may be possibly released from the suction by the first suction unit 2051. On the other hand, if the movement of the detaching roller 2340 is started before the detachment boundary line reaches the contact nip region R24, the detaching roller 2340 does not function to manage the progress of the detachment and the pattern or the like are damaged after all by the irregular progress of the detachment. Thus, the movement of the detaching roller 2340 is required to be started without delay when the detachment boundary line reaches the contact nip region R24.

In this embodiment, the above requirement is met by detecting a moving condition of the detachment boundary line in real time from images imaged by the imager 2037 and controlling the movement of the detaching roller 2340 based on that detection result. Specifically, a judgment line JL, being a reference position for determining a movement start timing of the detaching roller 2340, is set in advance for the detachment boundary line moving in the imaging visual field FV of the imager 2037. On that basis, the movement of the detaching roller 2340 is started when the arrival of the detachment boundary line at this judgment line JL is detected (Steps S207, S208).

The judgment line JL can be set, for example, at the position of the (−Y) side end part P24 of the contact nip region R24, i.e. the upstream end part in the detachment progressing direction. By doing so, the movement of the detaching roller 2340 can be started substantially simultaneously with the arrival of the detachment boundary line at the contact nip region R24. On the other hand, if there is a conceivable time lag between the arrival of the detachment boundary line at the judgment line JL and the start of the movement of the detaching roller 2340, a position shifted toward the upstream side in the detachment progressing direction from the upstream end part P24 of the contact nip region R24, i.e. toward the (−Y) side by a predetermined distance may be, for example, set as a reference position and the judgment line JL may be set at this position.

Further, as another method, a moving speed of the detachment boundary line in the imaging visual field FV may be detected from imaged images, a time at which the detachment boundary line reaches the contact nip region R24 may be predicted from that detection result and the movement of the detaching roller 2340 may be started at that timing. This can make a time difference between the arrival of the detachment boundary line at the contact nip region R24 and the start of the movement of the detaching roller 2340 substantially zero.

Note that, in either case, the contact nip region R24 in the initial stage is located closer to the (−Y) side than the effective region AR, i.e. set at a position deviating toward the upstream side in the detachment progressing direction (FIG. 13). Thus, even if there is a small time difference between the arrival of the detachment boundary line at the contact nip region R24 and the start of the movement of the detaching roller 2340, it is avoided that the pattern in the effective region AR is affected by that.

Thereafter, the first suction unit 2051 moves upward, i.e. in the (+Z) direction and the detaching roller 2340 moves in the (+Y) direction respectively at constant speeds. In this way, the movement of the detaching roller 2340 as well as the elevation of the first suction unit 2051 are started, whereby the detachment further progresses.

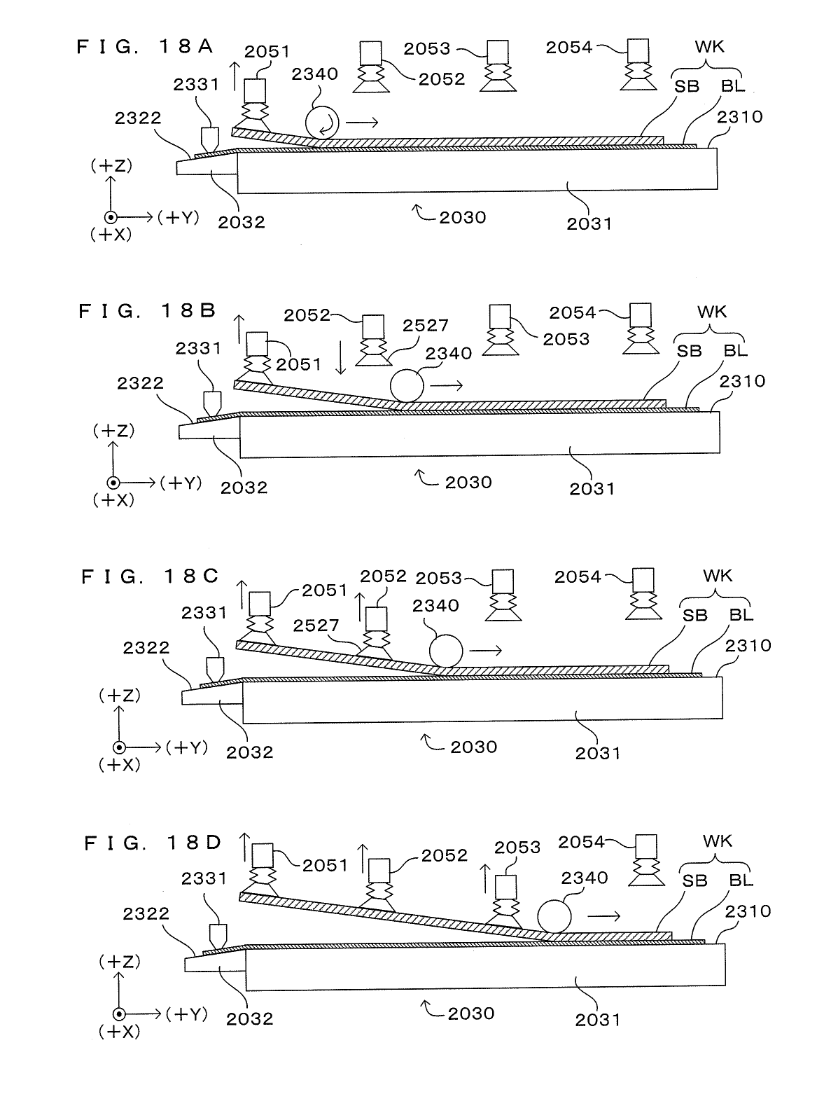

As shown in FIG. 18A, the substrate SB is pulled up and the detachment from the blanket BL progresses in the (+Y) direction by elevating the first suction unit 2051 holding the end part of the substrate SB. Since the detaching roller 2340 is held in contact, the detachment does not progress beyond the contact nip region R24 (FIG. 13) by the detaching roller 2340. By moving the detaching roller 2340 in contact with the substrate SB in the (+Y) direction at the constant speed, a detachment progressing speed can be maintained constant. Specifically, the detachment boundary line becomes a straight line extending in the roller extending direction, i.e. X direction and moves in the (+Y) direction at the constant speed. This can reliably prevent the damage of the pattern due to the concentration of a stress caused by a variation in the detachment progressing speed.

Thereafter, it is waited until the detaching roller 2340 passes a switching position set in advance (Step S209). This switching position is set in correspondence with each of the suction units 2052 to 2054 and a position on the substrate SB right below the corresponding suction unit. For example, the switching position corresponding to the second suction unit 2052 is a surface position of the substrate SB right below the second suction unit 2052. When the detaching roller 2340 passes this position, the second suction unit 2052 is lowered as shown in FIG. 18B. After the substrate SB is captured by the suction pads 2527 of the second suction unit 2052, the second suction unit 2052 is elevated again (Step S210).

As shown in FIG. 18B, since the detaching roller 2340 has already passed, the substrate SB is detached from the blanket BL and lifted up at the position right below the second suction unit 2052. By bringing the suction pads 2527 made of a stretchable elastic material closer to the substrate SB while applying a negative pressure thereto, the substrate SB can be captured and sucked when the lower surfaces of the suction pads 2527 come into contact with the upper surface of the substrate SB. It may be waited for the substrate SB being pulled up after the suction pads 2527 are lowered up to a predetermined position. In any case, a suction failure can be prevented by providing the suction pads with flexibility.

After the suction of the substrate SB is started, the movement of the suction unit 2052 is reversed to an elevating movement. By this, as shown in FIG. 18C, the main pull-up of the substrate SB for detachment is taken over from the first suction unit 2051 to the second suction unit 2052 while the detachment progressing speed remains to be controlled by the detaching roller 2340. Further, the holding of the substrate SB after the detachment is switched from a single holding mode holding only by the first suction unit 2051 to a double holding mode holding by the first and second suction units 2051, 2052, thereby increasing the number of the held positions. Note that relative positions of the respective suction units 2051 to 2054 in the Z direction are so maintained that the posture of the substrate SB after the detachment forms substantially a flat surface when the respective suction units 2051 to 2054 are elevated.

By performing a similar process (Steps S209 to S211) also for the remaining suction units 2053, 2054, the number of the held positions of the substrate SB by the suction units is successively increased and the suction unit for mainly pulling up the substrate SB is successively switched to the downstream suction unit as shown in FIG. 18D. After the process is finished for all the suction units (Step S211), the entire substrate SB is separated from the blanket BL. Accordingly, the detaching roller 2340 is moved further toward the (+Y) side than the stage 2030 and the movement thereof is stopped (Step S212). Then, all the suction units 2051 to 2054 are stopped after being elevated to the same height (Step S213). Further, the pressing member 2331 of the initial detaching unit 203 is separated from the blanket BL and moved to the retracted position above the upper surface of the blanket BL and closer to the (−Y) side than the (−Y) side end part of the blanket BL (Step S214). Thereafter, the suction holding of the blanket BL by the suction grooves is released and the separated substrate SB and the blanket BL are unloaded to the outside of the apparatus (Step S215), whereby the detaching process is completed.

All the suction units 2051 to 2054 are set at the same height to facilitate the access of an external robot or a delivery hand inserted by the operator and the transfer of the blanket BL and the substrate SB thereto by holding the substrate SB and the blanket BL after the detachment in parallel.

As described above, in this embodiment, the detaching roller 2340 extending in the X direction perpendicular to the detachment progressing direction (here, Y direction) is brought into contact with the substrate SB and the substrate SB is pulled up while the detaching roller 2340 is moved in the detachment progressing direction at the constant speed. By doing so, the substrate SB and the blanket BL can be satisfactorily detached while the detachment progressing speed is kept constant. Specifically, the shape and the moving speed of the detachment boundary line, formed between the detached region where the substrate SB and the blanket BL are already detached and the undetached region where they are not detached yet, can be controlled by the detaching roller 2340.

Particularly, the contact of the detaching roller 2340 is started between the (−Y) side end part PS of the substrate SB where the detachment is started and the effective region AR where an effective pattern or the like is formed. This realizes the progress management of the detachment by the detaching roller 2340 before reaching the detachment boundary line to the effective region AR. As a result, the damage on the pattern or the like in the effective region AR due to a variation in the detachment progressing speed can be prevented.

In the initial stage before the management by the detaching roller 2340 is established, the detachment progressing speed tends to be unstable. However, since an actual moving condition of the detachment boundary line is grasped from images imaged by the imager 2037 to determine the movement start timing of the detaching roller 2340 in this embodiment, the detaching roller 2340 can be moved in accordance with the actual movement of the detachment boundary line. This causes the detachment boundary line to smoothly move also before and after the start of the movement of the detaching roller 2340 and can reliably prevent the damage on the pattern or the like due to a variation in the detachment progressing speed.

Further, in this embodiment, the region R23 where the substrate SB is sucked by the first suction unit 2051 in charge of pulling up the substrate SB in the initial stage of the detachment is outside the effective region AR where the effective pattern is formed as shown in FIG. 13. By locally sucking the substrate SB, the substrate SB may be partly detached from the blanket BL in that part, whereby the pattern may be possibly affected by being deformed or damaged. However, such a problem is avoided by sucking the region outside the effective region. Further, although the detaching speed is unstable until the detachment boundary line reaches the position right below the detaching roller 2340, the damage of the pattern due to a variation in the detaching speed is also prevented by similarly setting the contact nip region R24 with the detaching roller 2340 in the initial stage outside the effective region.

On the other hand, since the second to fourth suction units 2052 to 2054 for newly sucking the substrate SB during the progress of the detachment come into contact with the substrate SB in a region already detached from the blanket BL, the pattern transferred to the substrate SB is not damaged by the suction in this case.

As described above, in this embodiment, the blanket BL of the work WK as an object for detachment corresponds to the “first plate-like body” of the invention, whereas the substrate SB corresponds to the “second plate-like body” of the invention. Further, the (−Y) side end part of the substrate SB corresponds to “one end part” of the invention and the (+Y) side end part opposite to this corresponds to “another end part” of the invention. The (+Y) direction corresponds to a “detachment progressing direction” of the invention.

Further, in this embodiment, the stage 2030 functions as a “holder” of the invention, and the upper surface 2310 of the horizontal stage section 2031 and the upper surface 2320 of the tapered stage section 2032 integrally function as a “holding surface” of the invention. Particularly, the upper surface 2310 of the horizontal stage section 2031 and the horizontal surface 2321 of the tapered stage section 2032 integrally functions as a “flat surface section” of the invention and the tapered surface 2322 of the tapered stage section 2032 functions as a “tapered surface section” of the invention.

Further, in this embodiment, the first suction unit 2051 functions as a “detacher” of the invention. Further, the detaching roller 2340 functions as a “contactor” of the invention, and the position of the contact nip region R24 by the detaching roller 2340 before the start of the movement shown in FIGS. 13 and 16A corresponds to a “contact start position” of the invention. Further, in the above embodiment, the imager 2037 functions an “imager” of the invention and the control unit 2070 functions as a “movement controller” of the invention. Further, the pressing member 2331 functions as a “pressing member” of the invention.

### <Modification of the Second Embodiment>

Note that the invention is not limited to the above embodiment and various changes other than the aforementioned one can be made without departing from the gist thereof. For example, in the above embodiment, one imaging window 2323 is provided substantially in the central part of the horizontal surface 2331 of the tapered stage section 2032 in the X direction and one imager 2037 is provided at the position right below the imaging window 2323. However, as described above, the movement of the detachment boundary line is irregular until the progress management by the detaching roller 2340 is established, and differs depending on the position. In view of this, the detachment boundary line may be imaged at a plurality of positions along the X direction and the start timing of the detaching roller may be determined from that result. In this case, the movement of the detaching roller is started in accordance with the detachment boundary line at a position corresponding to the slowest progress. By doing so, it is at least avoided that the roller starts moving before the detachment boundary line reaches the contact nip.

In a general rectangular substrate, the detachment tends to start from corner parts where a detaching force acts in a concentrated manner and starts at a delayed timing in the center of a side in many cases. In view of this, it is effective to set an imaging position in a central part if there is one imaging position and this embodiment corresponds to this case.

Further, although the substrate and the blanket are held by vacuum suction in the above embodiment, a holding mode is not limited to this. For example, the substrate and the blanket may be sucked and held by an electrostatic or magnetic suction force. Particularly, the first suction unit 2051 for holding the region of the substrate outside the effective region may hold the substrate peripheral edge part not by suction, but by mechanical gripping.

Further, although the stage 2030 is configured to be separable for the transfer convenience in loading and unloading the work WK in the above embodiment, a work loading/unloading mode is not limited to this and a separable structure of the stage is not an essential requirement.

Further, in the above embodiment, the blanket BL is so held as to project toward the tapered stage section 2032 and the detachment is triggered by bending the blanket BL by the pressing member 2331. However, the present invention can be preferably applied, for example, for a configuration for starting the detachment only by the pull-up of the first suction unit instead of by such a configuration. In this case, the stage needs not be tapered.

As described above, in the second aspect of the detaching apparatus according to this invention, the contactor may be, for example, configured to come into contact with the first plate-like body at the contact start position upstream of the effective region in the detachment progressing direction. In such a configuration, the progress management by the contactor is established before the boundary line reaches the effective region, wherefore the pattern or the like in the effective region is not damaged.

For example, a position corresponding to an upstream end part of the contact nip in the detachment progressing direction may be set as a reference position in advance and the movement of the contactor may be started when the arrival of the boundary line at the reference position is detected. In such a configuration, the movement of the contactor can be started without delay when the boundary line reaches the reference position.

For example, the reference position may be a position shifted from the position corresponding to the upstream end part of the contact nip in the detachment progressing direction toward the upstream side in the detachment progressing direction by a predetermined distance. In such a configuration, it is prevented that the movement of the boundary line is stopped by the contactor, for example, when time is required until the movement of the contactor starts and reaches a constant speed.

For example, a time at which the boundary line reaches the position corresponding to the upstream end part of the contact nip in the detachment progressing direction is predicted from the position detection result of the boundary line, and the movement of the contactor may be started at that predicted time. In such a configuration, the movement of the contactor can be controlled by grasping a timing at which such a movement is supposed to be started, and the boundary line can be smoothly moved.

Further, the holder for holding the first plate-like body may include a holding surface, for example, composed of a flat surface section which comes into contact with the effective region of the first plate-like body and a tapered surface section which is connected to the flat surface section and recedes from an extended flat surface from the flat surface section with a distance from a ridge section connected to the flat surface section and may be configured to hold the first plate-like body in such a manner that a peripheral edge part upstream of the effective region of the first plate-like body in the detachment progressing direction projects toward the tapered surface section from the flat surface section, whereas a pressing member may be further provided which starts detachment from the second plate-like body by bending the peripheral edge part of the first plate-like body toward a side opposite to the second plate-like body, and the contact start position may be located between the ridge section and the effective region.

In such a configuration, since the straight boundary line can be formed near the ridge section by bending the peripheral edge part of the first plate-like body in the initial stage of the detachment, the boundary line can be stabilized early. By bringing the contactor into contact with an area between the ridge section where the thus stabilized boundary line is first formed and the effective region as the contact start position, the movement management by the contactor can be more reliably established before the boundary line reaches the effective region.

In this case, for example, imaging may be performed via a light transmissive imaging window provided upstream of a position of the flat surface section corresponding to the effective region in the detachment progressing direction. In such a configuration, the detachment boundary line can be imaged from a side opposite to the first plate-like body via the holder. Thus, a degree of freedom in the disposed position of the imager is increased.

For example, the imager may image a central part of the first plate-like body in a direction perpendicular to the detachment progressing direction. In the initial stage of the detachment, the progress of the detachment may not necessarily be uniform in the direction perpendicular to the detachment progressing direction. In many cases, a stress acts on corner parts of a plate-like body in a concentrated manner and first detachment starts near the corner parts. Thus, the progress of the detachment observed near end parts in the direction perpendicular to the detachment progressing direction does not necessary indicate the overall progress of the detachment. By imaging the central part tended to be detached at a later timing, it is at least avoided that the movement of the contactor is started before the arrival of the detachment boundary line.

Further, in these inventions, the contactor is preferably moved in the detachment progressing direction at a constant speed after the start of the movement. In such a configuration, the damage on the pattern or the like due to a speed variation can be reliably prevented by allowing the detachment to progress at the constant speed.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A detaching apparatus for detaching a first plate-like body and a second plate-like body adhering to each other, the apparatus comprising:
a first holder that holds the first plate-like body;
a detachment starter that bends one end part of the first plate-like body into a cylindrical or prismatic surface in a direction opposite to the second plate-like body, thereby converting a part of an adhering region of the second plate-like body adhering to the first plate-like body into a detached region detached from the first plate-like body and forming a single and straight boundary line between the adhering region and the detached region;
a second holder that holds the second plate-like body formed with the detached region; and
a separator that increases a distance between the first and second holders to separate the first and second plate-like bodies.

2. The detaching apparatus according to claim 1, wherein
the first holder includes a planar contact surface and another surface connected to the planar contact surface and holds the first plate-like body in a state where at least a part of a ridge between the planar contact surface and the other surface is a straight line having a length not shorter than the length of the first plate-like body in a direction of the ridge, the planar contact surface is brought into contact with a surface of the first plate-like body opposite to a surface adhering to the second plate-like body and one end part of the first plate-like body projects further outward than the ridge from the planar contact surface and
the detachment starter bends the first plate-like body at the outer side of the ridge.

3. The detaching apparatus according to claim 2, wherein
the first plate-like body has a planar size larger than a planar size of the second plate-like body,
the first holder holds the first plate-like body in a state where a peripheral edge part of the first plate-like body not adhering to the second plate-like body projects to the outer side of the ridge and
the detachment starter includes a pressing member that presses the first plate-like body in a direction opposite to the second plate-like body by coming into contact with the peripheral edge part from the side of the second plate-like body.

4. The detaching apparatus according to claim 3, wherein
the pressing member uniformly comes into contact with the first plate-like body in a direction parallel to the ridge.

5. The detaching apparatus according to claim 1, wherein
a central part of the second plate-like body has an effective region carrying a pattern or a thin film and is adhered via the pattern or the thin film to the first plate-like body before starting the detachment and
the detachment starter preferably forms a boundary line outside the effective region.

6. The detaching apparatus according to claim 5, further comprising a contactor that comes into contact with the second plate-like body uniformly at a side opposite to the first plate-like body, outside the effective region and in the direction parallel to the boundary line.

7. The detaching apparatus according to claim 5, wherein
the first holder sucks and holds the first plate-like body at the outer side of a position facing the effective region and
the detachment starter bends the first plate-like body at the outer side of the part sucked and held by the first holder.

8. The detaching apparatus according to claim 1, wherein
the second holder holds a peripheral edge part of the second plate-like body closest to the position where the boundary line is formed.

9. The detaching apparatus according to claim 1, wherein
the separator increases a distance between the first and second holders at a constant speed.

10. A detaching apparatus for detaching a first plate-like body and a second plate-like body adhering to each other via a thin film or a pattern, the apparatus comprising:
a holder that has a holding surface larger than a planar size of an effective region of the first plate-like body in which the thin film or the pattern is effectively carried and is configured to hold the first plate-like body by the contact of the holding surface with a surface of the first plate-like body opposite to a surface adhering to the second plate-like body;
a contactor that has a roller shape whose axial direction is perpendicular to a detachment progressing direction, is configured to be movable in the detachment progressing direction and forms a contact nip by coming into contact with a surface of the second plate-like body opposite to a surface adhering to the first plate-like body at a contact start position downstream of the one end part in the detachment progressing direction, the detachment progressing direction being a direction from one end part to another end part of the second plate-like body along the second plate-like body;
a detacher that holds and moves the one end part in a direction away from the holder, thereby detaching the one end part from the first plate-like body;
an imager that images a boundary line formed on a boundary between an undetached region of the first plate-like body adhering to the second plate-like body and a detached region thereof detached from the second plate-like body via the first plate-like body; and
a movement controller that detects the position of the boundary line based on an image imaged by the imager and controls a movement of the contactor based on the detection result, wherein
the contactor starts moving in the detachment progressing direction from the contact start position when the boundary line reaches a position corresponding to an upstream end part of the contact nip in the detachment progressing direction.

11. The detaching apparatus according to claim 10, wherein
the contact start position is located upstream of an upstream end part of the effective region in the detachment progressing direction.

12. The detaching apparatus according to claim 10, wherein
the movement controller starts moving the contactor when the arrival of the boundary line at a reference position set in advance is detected and
the reference position is a position corresponding to an upstream end part of the contact nip in the detachment progressing direction.

13. The detaching apparatus according to claim 10, wherein
the movement controller starts moving the contactor when the arrival of the boundary line at a reference position set in advance is detected and
the reference position is a position shifted from a position corresponding to the upstream end part of the contact nip in the detachment progressing direction toward the upstream side in the detachment progressing direction by a predetermined distance.

14. The detaching apparatus according to claim 10, wherein
the movement controller starts moving the contactor at a time at which the boundary line reaches a position corresponding to the upstream end part of the contact nip in the detachment progressing direction, the time being predicted from the position detection result of the boundary line.

15. The detaching apparatus according to claim 10, further comprising a pressing member, wherein
the holding surface of the holder includes a flat surface section and a tapered surface section, the flat surface section coming into contact with the effective region of the first plate-like body, the tapered surface section being connected to the flat surface section and receding from an extended flat surface from the flat surface section with a distance from a ridge section connected to the flat surface section,
the holder holds the first plate-like body in such a manner that a peripheral edge part upstream of the effective region of the first plate-like body in the detachment progressing direction projects toward the tapered surface section from the flat surface section,
the pressing member starts detachment from the second plate-like body by bending the peripheral edge part of the first plate-like body toward a side opposite to the second plate-like body and
the contact start position is located between the ridge section and the effective region.

16. The detaching apparatus according to claim 15, wherein
the imager images via a light transmissive imaging window provided upstream of a position of the flat surface section corresponding to the effective region in the detachment progressing direction.

17. The detaching apparatus according to claim 10, wherein
the imager images a central part of the first plate-like body in a direction perpendicular to the detachment progressing direction.

18. A detaching method for detaching a first plate-like body and a second plate-like body adhering to each other, the method comprising:
a boundary line forming step of bending one end part of the first plate-like body into a cylindrical or prismatic surface in a direction opposite to the second plate-like body, thereby converting a part of an adhering region of the second plate-like body adhering to the first plate-like body into a detached region detached from the first plate-like body and forming a single and straight boundary line between the adhering region and the detached region; and
a detaching step of moving the boundary line toward the adhering region while maintaining the boundary line straight by relatively moving the first and second plate-like bodies in a separating direction.

19. The detaching method according to claim 18, further comprising a setting step of bringing the first plate-like body into contact with the flat surface section of a stage in a state where one end part of the first plate-like body projects further outward than the ridge of the flat surface section of the stage prior to the boundary line forming step, wherein
the one end part is pressed in a direction opposite to the second plate-like body from a side opposite to the stage in the boundary line forming step.

20. The detaching method according to claim 19, wherein
a central part of the second plate-like body has an effective region carrying a pattern or a thin film and is adhered via the pattern or the thin film to the first plate-like body before starting the detachment and
in the setting step, a part of the first plate-like body outside the region facing the effective region is brought into contact with the ridge of the flat surface section.

21. The detaching method according to claim 18, wherein
in the detaching step, the contactor is relatively moved to a side opposite to the detached region with respect to the second plate-like body in synchronization with separating movements of the first and second plate-like bodies while the contactor extending in a direction perpendicular to a direction of the boundary line is brought into contact with a surface of the second plate-like body opposite to the first plate-like body.

22. A detaching method for detaching a first plate-like body and a second plate-like body adhering to each other via a thin film or a pattern, the method comprising:
a step of holding the first plate-like body by bringing a surface opposite to a surface adhering to the second plate-like body into contact with a holding surface having a planner size larger than a planar size of an effective region of the first plate-like body in which the thin film or the pattern is effectively carried;
a step of forming a contact nip by bringing a roller-shaped contactor whose axial direction is perpendicular to a detachment progressing direction into contact with a surface of the second plate-like body opposite to a surface adhering to the first plate-like body at a contact start position downstream of the one end part in the detachment progressing direction, the detachment progressing direction being a direction from one end part to another end part of the second plate-like body is the detachment progressing direction along the second plate-like body;
a step of moving the one end part of the second plate-like body in a direction away from the first plate-like body, thereby detaching the one end part of the second plate-like body from the first plate-like body;
a step of imaging a boundary line formed on a boundary between an undetached region of the first plate-like body adhering to the second plate-like body and a detached region thereof detached from the second plate-like body via the first plate-like body; and
a step of calculating a time, at which the boundary line reaches a position corresponding to an upstream end part of the contact nip in the detachment progressing direction, based on an imaged image and causing the contactor to start moving in the detachment progressing direction from the contact start position at the calculated time.

23. The detaching method according to claim 22, wherein
a position corresponding to an upstream end part of the contact nip in the detachment progressing direction is set as a reference position in advance and
the movement of the contactor is started when the arrival of the boundary line at the reference position is detected.

24. The detaching method according to claim 22, wherein
the reference position is a position shifted from the position corresponding to the upstream end part of the contact nip in the detachment progressing direction toward the upstream side in the detachment progressing direction by a predetermined distance in advance and
the movement of the contactor is started when the arrival of the boundary line at the reference position is detected.

25. The detaching method according to claim 22, wherein
a time at which the boundary line reaches the position corresponding to the upstream end part of the contact nip in the detachment progressing direction is predicted from the position detection result of the boundary line and
the movement of the contactor is started at that predicted time.

26. The detaching method according to claim 22, wherein
the contactor is preferably moved in the detachment progressing direction at a constant speed after the start of the movement.
